(19) United States
(12) Patent Application Publication
(10) Pub. No.: US 2023/0214004 A1
(43) Pub. Date: Jul. 6, 2023

(54) INFORMATION PROCESSING APPARATUS, INFORMATION PROCESSING METHOD, AND INFORMATION PROCESSING PROGRAM

(71) Applicant: SONY GROUP CORPORATION, TOKYO (JP)

(72) Inventors: TSUYOSHI ISHIKAWA, TOKYO (JP); JUN KIMURA, TOKYO (JP); SOICHIRO INATANI, TOKYO (JP); SHINICHI KAWANO, TOKYO (JP); IKUO YAMANO, TOKYO (JP)

(21) Appl. No.: 17/998,578

(22) PCT Filed: May 13, 2021
(86) PCT No.: PCT/JP2021/018224

§ 371 Date: Nov. 11, 2022

(30) Foreign Application Priority Data
May 21, 2020 (JP) 2020-088930

(51) Int. Cl. G06F 3/01; G06F 3/0346; G06F 3/16

(52) U.S. Cl. CPC G06F 3/011; G06F 3/016; G06F 3/167; G06F 3/0346; G06F 2203/0331

(57) ABSTRACT

An information processing apparatus according to an embodiment includes: an acquisition unit (100) that acquires motion information indicating a motion of a user, and a display control unit (100) that performs display control on a display unit capable of superimposing and displaying a virtual space on a real space. The display control unit specifies a real surface that is a surface in the real space based on the motion information, and displays a region image indicating a region for arranging a virtual object or a real object on a virtual surface that is a surface in the virtual space corresponding to the real surface according to an azimuth extracted based on the real surface.

### FIELD

The present disclosure relates to an information processing apparatus, an information processing method, and an information processing program.

### BACKGROUND

Augmented reality (AR) has become widespread as a technology for realizing realistic experience. The augmented reality is also called augmented reality (AR), and is a technology for adding, emphasizing, attenuating, or deleting information to a real environment surrounding a user to expand a real space viewed from the user. AR is realized by using, for example, a see-through type head mounted display (hereinafter, also referred to as “AR glasses”). According to the AR technology, superimposed display of a virtual object with respect to a scenery in a real space observed by a user through AR glasses, emphasis or attenuation display of a specific real object, display in which a specific real object is deleted and appears as if it does not exist, and the like are realized.

Meanwhile, Patent Literature 1 discloses a laser marking device that irradiates four surfaces of two opposing side walls, a ceiling, and a floor in a real space with line light indicating a vertical surface using laser light. In this laser marking device, for example, by placing the device on a floor surface, it is possible to irradiate four surfaces of a wall surface, a ceiling, and a floor with line light indicating a vertical surface with the floor surface as a reference plane. For example, in interior construction, it is possible to perform construction work such as installation of an object in a room or opening a hole in a wall surface, a floor, or a ceiling based on the line light.

### CITATION LIST

### Patent Literature

Patent Literature 1: JP 2005-010109 A

### SUMMARY

### Technical Problem

It is easy to display a line in a virtual space using an AR technology. However, in the conventional AR technology, it is difficult to set a plane as a reference for displaying a line, and it is difficult to present display as a reference such as installation of an object in a real space in a virtual space. Therefore, work such as arrangement of objects in the real space may be difficult.

An object of the present disclosure is to provide an information processing apparatus, an information processing method, and an information processing program capable of more easily executing work in a real space.

### Solution to Problem

For solving the problem described above, an information processing apparatus according to one aspect of the present disclosure has an acquisition unit configured to acquire motion information indicating a motion of a user; and a display control unit configured to perform display control on a display unit capable of superimposing and displaying a virtual space on a real space, wherein the display control unit specifies a real surface that is a surface in the real space based on the motion information, and displays a region image indicating a region for arranging a virtual object or a real object on a virtual surface that is a surface in the virtual space corresponding to the real surface according to an azimuth extracted based on the real surface.

### BRIEF DESCRIPTION OF DRAWINGS

FIG. 1A is a block diagram illustrating a configuration example of an AR glass system applicable to the disclosure.

FIG. 1B is a block diagram illustrating a configuration example of an AR glass system applicable to the disclosure.

FIG. 1C is a block diagram illustrating a configuration example of an AR glass system applicable to the disclosure.

FIG. 2 is a schematic diagram schematically illustrating an appearance of an AR glasses applicable to each embodiment.

FIG. 3 is a functional block diagram of an example for describing functions of AR glasses and a hand sensor applicable to each embodiment.

FIG. 4 is a schematic diagram illustrating an appearance example of the hand sensor applicable to each embodiment.

FIG. 5 is a functional block diagram of an example for describing functions of a control unit applicable to each embodiment.

FIG. 6 is a schematic diagram illustrating a display example of a virtual object by AR glasses applicable to each embodiment.

FIG. 7 is a schematic diagram for describing a mechanism for displaying a virtual object so that the AR glasses follow the motion of a head of a user, which is applicable to each embodiment.

FIG. 8 is a block diagram illustrating a hardware configuration of an example of the AR glasses applicable to each embodiment.

FIG. 9 is a block diagram illustrating a hardware configuration of an example of the hand sensor applicable to each embodiment.

FIG. 10 is a flowchart schematically illustrating an example of processing by the AR glasses according to the first embodiment.

FIG. 11 is a schematic diagram for describing a first designation method of a plane according to the first embodiment.

FIG. 12 is a schematic diagram for describing another example of the first designation method of the plane according to the first embodiment.

FIG. 13 is a schematic diagram for describing a fourth designation method of the plane according to the first embodiment.

FIG. 14A is a schematic diagram for describing a first designation method of an orientation according to the first embodiment.

FIG. 14B is a schematic diagram for describing another example of the first designation method of the orientation according to the first embodiment.

FIG. 15 is a schematic diagram for describing a third designation method of the orientation according to the first embodiment.

FIG. 16 is a flowchart illustrating an example of processing in a case where designation of a plane and designation of an orientation of a region image are executed by a series of motions of a hand (finger) according to the first embodiment.

FIG. 17 is a schematic diagram illustrating a specific example of display of a region image applicable to the first embodiment.

FIG. 18 is a schematic diagram illustrating an example in which a grid is expanded and displayed, which is applicable to the first embodiment.

FIG. 19 is a schematic diagram illustrating an example in which a grid is expanded and displayed in the entire virtual space, which is applicable to the first embodiment.

FIG. 20 is a diagram schematically illustrating an example in which a grid is displayed on a virtual surface for a real surface designated in a building model, applicable to the first embodiment.

FIG. 21 is a diagram schematically illustrating an example of a case where a line indicating a vertical surface is projected on a surface of a real space using laser light according to an existing technology.

FIG. 22 is a diagram schematically illustrating an example of a case where a grid is displayed in a virtual space according to the first embodiment.

FIG. 23 is a diagram schematically illustrating a state in which an object is arranged in a real space in which a grid is displayed on a virtual surface corresponding to a real surface in the virtual space.

FIG. 24 is a diagram illustrating an example of a coordinate space including an origin and three-dimensional coordinates according to a position and a posture acquired based on a feature amount with respect to an object according to a second embodiment.

FIG. 25 is a diagram schematically illustrating an example in which the coordinate space is displayed in association with each real object arranged in the real space in the virtual space according to the second embodiment.

FIG. 26 is a schematic diagram for describing still another example of acquiring a position and a posture of the real object according to the second embodiment.

FIG. 27 is a schematic diagram for describing a method of setting the coordinate space for the partially deformed real object according to a second embodiment.

FIG. 28 is a schematic diagram for describing processing of an example according to a modification of the second embodiment.

FIG. 29 is a schematic diagram schematically illustrating an operation according to a third embodiment.

FIG. 30 is a schematic diagram illustrating an example of a pattern of a notification according to the third embodiment.

FIG. 31 is a schematic diagram for describing a first method of displaying according to a fourth embodiment.

FIG. 32 is a schematic diagram for describing a second method of displaying according to the fourth embodiment.

FIG. 33 is a schematic diagram schematically illustrating an operation according to a fifth embodiment.

FIG. 34A is a schematic diagram illustrating a display example of a reduced virtual space according to a sixth embodiment.

FIG. 34B is a schematic diagram schematically illustrating an operation of moving a virtual object in a reduced virtual space according to a user operation according to the sixth embodiment.

### DESCRIPTION OF EMBODIMENTS

Hereinafter, embodiments of the present disclosure will be described in detail with reference to the drawings. Note that, in the following embodiments, the same parts are denoted by the same reference numerals, and redundant description will be omitted.

Hereinafter, embodiments of the present disclosure will be described in the following order.
1. Summary of Present Disclosure
2. Technology Applicable to Embodiments
3. First Embodiment
3-1. Outline of Processing of First Embodiment
3-2. Designation Method of Plane
3-3. Designation Method of Orientation of Region Image
3-4. Designation Method of Density of Region Image
3-5. Specific Example of Region Image
3-6. Comparison with Existing Technology
4. Second Embodiment
4-0-1. Display Coordinate Space in Virtual Space
4-0-2. Processing on Real Object Partially Deformed
4-1. Modification of Second Embodiment
5. Third Embodiment
6. Fourth Embodiment
6-1. First Display Method
6-2. Second Display Method
7. Fifth Embodiment
8. Sixth Embodiment

### 1. Overview of Present Disclosure

First, an outline of a technology according to the present disclosure will be described. The present disclosure relates to an augmented reality (AR) technology, and uses an AR glasses including a display unit that can be used by being worn on a head of a user and can display a virtual space superimposed on a real space, and an acquisition unit that acquires motion information indicating a motion of the user. The acquisition unit is realized as one of functions in the AR glasses.

In the AR glasses, a display control unit for controlling display by the display unit specifies a surface (referred to as a real surface) in the real space based on the motion information acquired by the acquisition unit, and sets a surface (referred to as a virtual surface) corresponding to the specified real surface in the virtual space. The display control unit displays, for example, a region image indicating a region for arranging a real object or a virtual object on the virtual surface according to an azimuth extracted based on the real surface.

In the present disclosure, as described above, the virtual surface for displaying the region image indicating the region for arranging the real object or the virtual object and the azimuth thereof are determined according to the motion of the user. Therefore, the user can easily acquire information on the position and azimuth in the real space or the virtual space. Furthermore, the user can more accurately execute the arrangement of the real object with respect to the real space and the arrangement of the virtual object with respect to the virtual space.

### 2. Technology Applicable to Embodiment

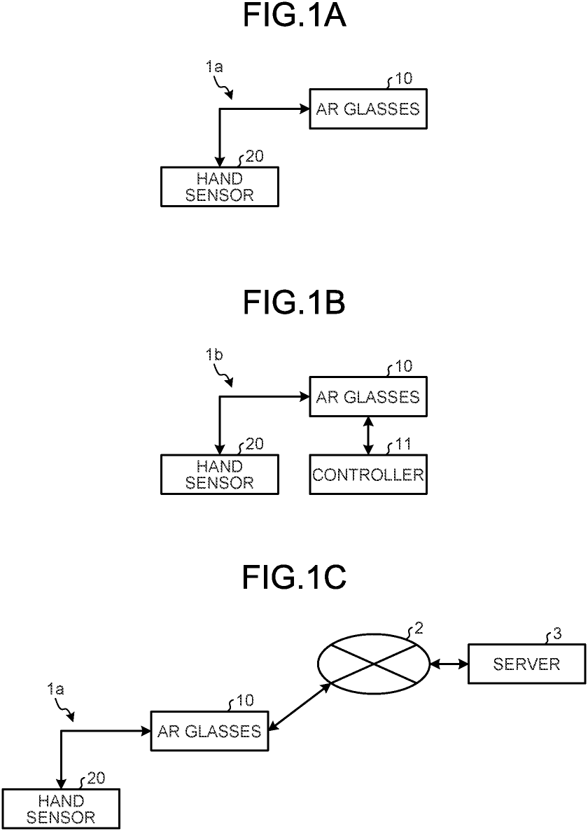

Prior to describing an information processing apparatus according to each embodiment of the present disclosure, a technology applicable to each embodiment will be described. FIGS. 1A, 1B, and 1C are block diagrams illustrating a configuration example of an AR glass system applicable to the present disclosure.

In FIG. 1A, an AR glass system 1a includes AR glasses 10 and a hand sensor 20. The AR glasses 10 are worn like glasses on a head of the user, and include a display unit capable of displaying the virtual space superimposed on the real space. The hand sensor 20 is attached to the hand of the user, and can detect the posture, position, and motion of the hand of the user. The hand sensor 20 is connected to the AR glasses 10 by communication means such as wireless communication or wired communication, and transmits detection results of the posture, the position, and the motion to the AR glasses 10 via the communication means. Furthermore, the AR glasses 10 can transmit an instruction or the like to the hand sensor 20 to the hand sensor 20 via this communication means.

An AR glass system 1b illustrated in FIG. 1B has a configuration in which a controller 11 is added to the configuration of FIG. 1A. The controller 11 is provided with an operator such as a button to be operated by a user, for example. The AR glasses 10 are connected by communication means such as wireless communication or wired communication, and for example, a control signal according to a user operation is transmitted to the AR glasses 10 via the communication means to control the operation of the AR glasses 10. In addition, the controller 11 can include a function of emitting beam light for pointing a point in the real space.

Note that, in FIG. 1B, the hand sensor 20 and the controller 11 are illustrated as separate components, but this is not limited to this example, and the hand sensor 20 and the controller 11 may be integrally configured.

In an AR glass system 1c illustrated in FIG. 1C, with respect to the configuration of FIG. 1A, the AR glasses 10 can be connected to the network 2 such as the Internet, and communication can be performed between a server 3 and the AR glasses 10 connected to the network 2. In this case, the AR glasses 10 can download and use the data included in the server 3 via the network 2. Note that the network 2 and the server 3 illustrated in FIG. 1C may be cloud networks.

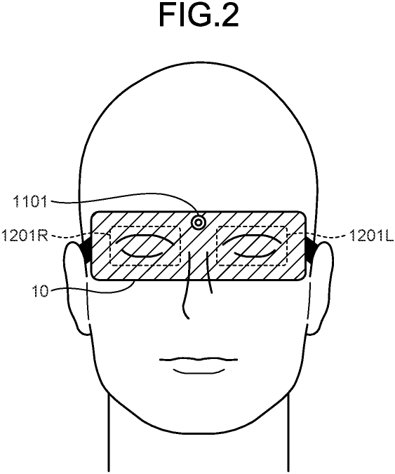

FIG. 2 is a schematic diagram schematically illustrating an appearance of the AR glasses 10 applicable to each embodiment. A main body of the AR glasses 10 is generally a glasses-type or goggle-type device, is used by being worn on the head of the user, and ca realize superimposed display of digital information with respect to visual fields of both eyes or one eye of the user, enhancement or attenuation of an image of a specific real object, deletion of an image of a specific real object to make the real object appear as if the real object does not exist at all, and the like. FIG. 2 illustrates a state in which the AR glasses 10 are worn on the head of the user.

In FIG. 2, in the AR glasses 10, a display unit 1201L for the left eye and a display unit 1201R for the right eye are disposed in front of the left and right eyes of the user, respectively. The display units 1201L and 1201R are transparent or translucent, and are capable of superimposing and displaying a virtual object on a scenery in a real space, emphasizing or attenuating an image of a specific real object, deleting an image of a specific real object and making the real object image appear as if the real object image does not exist at all, and the like. The left and right display units 1201L and 1201R may be independently display-driven, for example, to display a parallax image, that is, a virtual object as three-dimensional information. Furthermore, an outward camera 1101 directed in a line-of-sight direction of the user is arranged substantially at the center of the AR glasses 10.

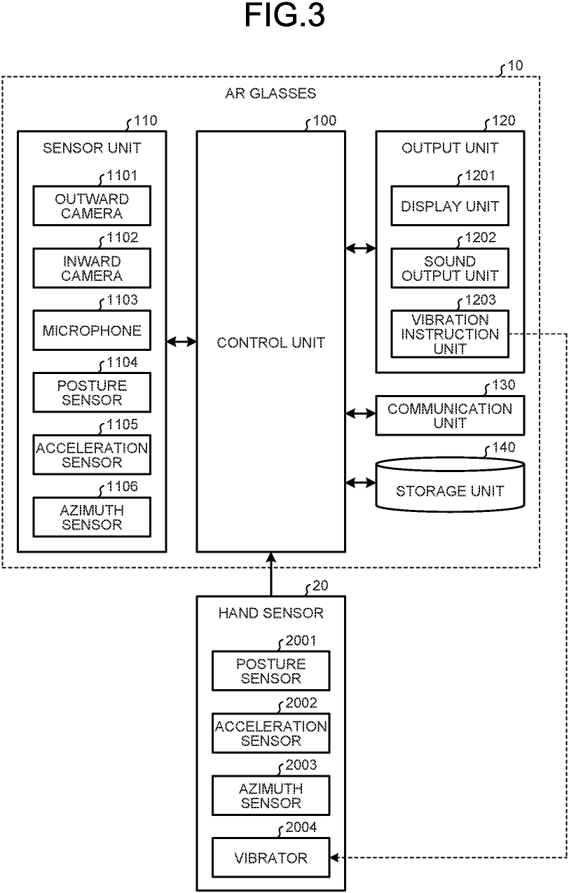

FIG. 3 is a functional block diagram of an example for describing the functions of the AR glasses 10 and the hand sensor 20 applicable to each embodiment. In FIG. 3, the AR glasses 10 include a control unit 100, a sensor unit 110, and an output unit 120. The control unit 100 controls the entire operation of the AR glasses 10.

The sensor unit 110 includes the outward camera 1101, an inward camera 1102, a microphone 1103, a posture sensor 1104, an acceleration sensor 1105, and an azimuth sensor 1106.

As the outward camera 1101, for example, an RGB camera capable of outputting a so-called full-color captured image of each color of red (R), green (G), and blue (B) can be applied. The outward camera 1101 is arranged in the AR glasses 10 so as to capture an image in the line-of-sight direction of the user wearing the AR glasses 10. The outward camera 1101 is capable of imaging, for example, a motion of a finger of the user.

Furthermore, the outward camera 1101 may further include at least one of an IR camera including an IR light emitting unit that emits infrared (IR) light and an IR light receiving unit that receives IR light, and a time of flight (TOF) camera for performing distance measurement based on a time difference between light emission timing and light reception timing. In a case where the IR camera is used as the outward camera 121, a retroreflective material is attached to an object to be captured such as a back of a hand, infrared light is emitted by the IR camera, and infrared light reflected from the retroreflective material can be received.

The inward camera 1102 includes, for example, an RGB camera, and is installed to be able to photograph the inside of the AR glasses 10, more specifically, the eye of the user wearing the AR glasses 10. The line-of-sight direction of the user can be detected based on the photographed image of the inward camera 1102.

Image signals of the images captured by the outward camera 1101 and the inward camera 1102 are transferred to the control unit 100.

As the microphone 1103, a microphone using a single sound collection element can be applied. The present invention is not limited thereto, and the microphone 1103 may be a microphone array including a plurality of sound collection elements. The microphone 1103 collects a voice uttered by the user wearing the AR glasses 10 and an ambient sound of the user. A sound signal based on the sound collected by the microphone 1103 is transferred to the control unit 100.

The posture sensor 1104 is, for example, a 3-axis or 9-axis gyro sensor, and detects the posture of the AR glasses 10, for example, roll, pitch, and yaw. The acceleration sensor 1105 detects acceleration applied to the AR glasses 10. The azimuth sensor 1106 is, for example, a geomagnetic sensor, and detects the azimuth in which the AR glasses 10 face. For example, a current position with respect to an initial position of the AR glasses 10 can be obtained based on the detection result of the acceleration sensor 1105 and the detection result of the azimuth sensor 1106. The posture sensor 1104, the acceleration sensor 1105, and the azimuth sensor 1106 may be configured by an inertial measurement unit (IMU).

Each sensor signal output from each of the posture sensor 1104, the acceleration sensor 1105, and the azimuth sensor 1106 is transferred to the control unit 100. The control unit 100 can detect the position and posture of the head of the user wearing the AR glasses 10 based on these sensor signals.

The output unit includes a display unit 1201, a sound output unit 1202, and a vibration presentation unit 1203. Note that, here, the left and right display units 1201L and 1201R illustrated in FIG. 2 are represented by the display unit 1201.

The display unit 1201 includes a transmissive display installed in front of both eyes or one eye of the user wearing the AR glasses 10, and is used to display the virtual world. More specifically, the display unit 1201 performs display of information (for example, an image of a virtual object), and display of emphasis, attenuation, deletion, or the like of an image of a real object to expand the real space viewed from the user. The display unit 1201 performs a display operation in accordance with a display control signal from the control unit 100. In addition, a mechanism of transparently displaying a virtual space image with respect to a real space image in the display unit 1201 is not particularly limited.

The sound output unit 1202 includes a single sounding element that converts a sound signal supplied from the control unit 100 into a sound as aerial vibration and outputs the sound, or an array of a plurality of sounding elements, and constitutes a speaker or an earphone. The sound output unit 1202 is arranged, for example, on at least one of the left and right ears of the user in the AR glasses 10. The control unit 100 can cause the sound output unit 1202 to output a sound related to the virtual object displayed on the display unit 1201. The present invention is not limited to this, and the control unit 100 can also cause the sound output unit 1202 to output sounds by other types of sound signals.

Under the control of the control unit 100, the vibration presentation unit 1203 generates, for the hand sensor 20, a control signal for giving a stimulus (for example, vibration) to the finger of the user wearing the hand sensor 20.

A communication unit 130 communicates with the hand sensor 20 via wireless communication or wired communication. The communication unit 130 communicates with the hand sensor 20 using, for example, wireless communication by Bluetooth (registered trademark). The communication method by which the communication unit 130 communicates with the hand sensor is not limited to Bluetooth (registered trademark). Furthermore, the communication unit 130 can execute communication via a network such as the Internet. As an example, in the AR glass system 1c illustrated in FIG. 1C, the communication unit 130 communicates with the server 3 via the network 2.

A storage unit 140 can store data generated by the control unit 100 and data used by the control unit 100 in a nonvolatile manner.

In FIG. 3, the hand sensor 20 includes a posture sensor 2001, an acceleration sensor 2002, an azimuth sensor 2003, and a vibrator 2004. Among these sensors, the posture sensor 2001, the acceleration sensor 2002, and the azimuth sensor 2003 have functions corresponding to the posture sensor 1104, the acceleration sensor 1105, and the azimuth sensor 1106 described above, respectively, and detect the posture, the acceleration, and the azimuth of the hand sensor 20. As will be described later, in the hand sensor 20, for example, the azimuth of the hand sensor 20 can be detected based on the direction pointed by the index finger of the user.

As in the case of the sensor unit 110, the posture sensor 2001, the acceleration sensor 2002, and the azimuth sensor 2003 may be configured by an inertial measurement unit (IMU). In the following description, it is assumed that the posture sensor 2001, the acceleration sensor 2002, and the azimuth sensor 2003 are constituted by an IMU.

The vibrator 2004 is supplied with the control signal generated by the vibration presentation unit 1203 described above, and performs an operation of giving a stimulus (vibration in this example) to the hand of the user wearing the hand sensor 20 according to the control signal.

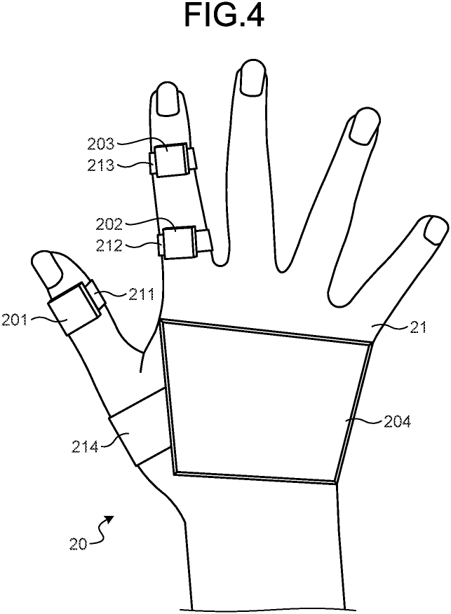

FIG. 4 is a schematic diagram illustrating an appearance example of the hand sensor 20 applicable to each embodiment. In the example of FIG. 4, the hand sensor 20 includes IMUs 201, 202, and 203 that implement the functions of the posture sensor 2001, the acceleration sensor 2002, and the azimuth sensor 2003 described above, respectively, and a hand sensor control unit 204.

The IMU 201 is mounted between an MP joint and an IP joint of the first finger (thumb) of a hand 21 by a belt 211 or the like. The IMUs 202 and 203 are respectively mounted by belts 212 and 213 and the like between an MP joint and a PIP joint and between the PIP joint and a DIP joint of the second finger (index finger) of the hand 21. The direction pointed by the second finger can be obtained based on the sensor signals of the two IMUs 202 and 203 worn on the second finger.

More specifically, the control unit 100 can detect the opening angle between the first finger and the second finger, the angle of the PIP joint (second joint) of the second finger, the presence or absence of contact between the fingertips of the first finger and the second finger, and the like based on the sensor signals output from the IMUs 201, 202, and 203. As a result, the control unit 100 can recognize the position and posture (Alternatively, a form taken by a finger) of the finger of the user in the hand 21 and the gesture by the fingers.

The hand sensor control unit 204 is wound around the palm of the hand 21 by a belt 214 or the like and attached. The hand sensor control unit 204 includes a communication unit (not illustrated) that communicates with the AR glasses 10 and the vibrator 2004. The hand sensor control unit 204 transmits each sensor signal output from the IMUs 201 to 203 to the AR glasses 10 by the communication unit. The hand sensor control unit 204 includes the vibrator 2004. The hand sensor control unit 204 vibrates the vibrator 2004 according to the control signal generated by the vibration presentation unit 1203 and transmitted from the AR glasses 10, and can give a stimulus to the hand 21 on which the hand sensor 20 is worn.

In the example of FIG. 4, the IMU is worn only on the first finger and the second finger, but this is not limited to this example, and the IMU can be further worn on other fingers of the hand 21. In addition, in the example of FIG. 4, the hand sensor 20 is illustrated to be worn on the right hand of the user, but this is not limited to this example. For example, the hand sensor 20 may be worn on the left hand of the user, or may be worn on each of the left and right hands of the user.

FIG. 5 is a functional block diagram of an example for describing the function of the control unit 100 applicable to each embodiment. In FIG. 5, the control unit 100 includes an application execution unit 1001, a head position/posture detection unit 1002, an output control unit 1003, a finger position/posture detection unit 1004, and a finger gesture detection unit 1005.

The application execution unit 1001, the head position/posture detection unit 1002, the output control unit 1003, the finger position/posture detection unit 1004, and the finger gesture detection unit 1005 are realized by reading and executing an information processing program stored in the storage unit 140, for example, by a central processing unit (CPU) included in the AR glasses 10 to be described later. Not limited to this, some or all of the application execution unit 1001, the head position/posture detection unit 1002, the output control unit 1003, the finger position/posture detection unit 1004, and the finger gesture detection unit 1005 may be configured by a hardware circuit that operates in cooperation with each other.

In FIG. 5, the application execution unit 1001 executes an application program including an AR application under an execution environment provided by an operating system (OS). The application execution unit 1001 may simultaneously execute a plurality of application programs in parallel. The AR application is, for example, an application such as moving image reproduction or a viewer of a 3D object. The AR application executes superimposed display of a virtual space with respect to the field of view of the user wearing the AR glasses 10 on the head, emphasis or attenuation display of an image of a specific real object, display of deleting an image of a specific real object to make the real object appear as if the real object does not exist at all, and the like.

Furthermore, the AR application can acquire three-dimensional information of the surroundings based on the captured image acquired by the outward camera 1101. In a case where the outward camera 1101 includes a TOF camera, the AR application can acquire surrounding three-dimensional information based on distance information obtained using the function of the TOF camera. Furthermore, the AR application can also analyze the sound signal output from the microphone 1103 and acquire an instruction by utterance of the user wearing the AR glasses 10, for example. Furthermore, the AR application can acquire an instruction by the user based on a gesture detected by the finger gesture detection unit 1005 to be described later.

The application execution unit 1001 further generates a display control signal for controlling display on the display unit 1201, and controls the display operation of the virtual object on the display unit 1201 by the AR application according to the generated display control signal. The virtual object generated by the AR application is arranged around the entire circumference of the user.

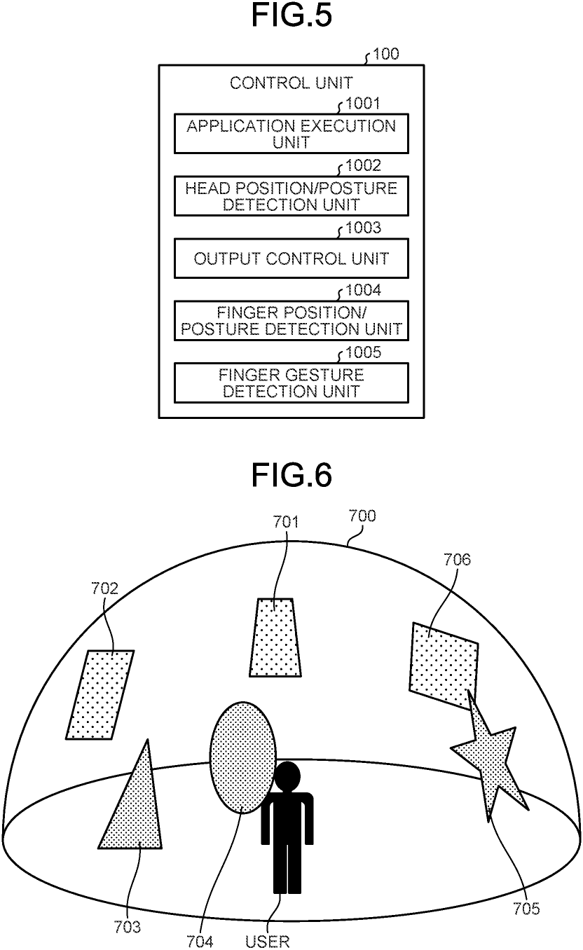

FIG. 6 is a schematic diagram illustrating a display example of the virtual object by the AR glasses 10 applicable to each embodiment. As schematically illustrated in FIG. 6, a plurality of virtual objects 701, 702, 703,... are arranged at a surrounding 700 of the user wearing the AR glasses 10 on the head. The application execution unit 1001 arranges each of the virtual objects 701, 702, 703,... at the surrounding 700 of the user based on the position of the head or a position of gravity of the body of the user estimated based on the sensor signal output from the sensor unit 110. A space of the surrounding 700 of the user where the virtual objects 701, 702, 703,... are arranged is called a virtual space with respect to the real space where a real physical object (real object) exists.

The head position/posture detection unit 1002 detects the position and posture of the head of the user based on the sensor signals of the posture sensor 1104, the acceleration sensor 1105, and the azimuth sensor 1106 included in the sensor unit 110 mounted on the AR glasses 10, and further recognizes the line-of-sight direction or the visual field range of the user.

The output control unit 1003 controls outputs of the display unit 1201, the sound output unit 1202, and the vibration presentation unit 1203 based on an execution result of an application program such as an AR application. For example, the output control unit 1003 specifies the visual field range of the user based on the detection result of the head position/posture detection unit 1002, and controls the display operation of the virtual object by the display unit 1201 so that the user can observe the virtual object arranged in the visual field range through the AR glasses 10, that is, so as to follow the motion of the head of the user.

Furthermore, the output control unit 1003 can superimpose and display the image of the virtual space on the image of the real space transmitted through the display units 1201L and 1201R. That is, in the AR glasses 10, the control unit 100 functions as a display control unit that performs display control of superimposing the virtual space on the real space and displaying the virtual space on the display units 1201L and 1201R by the output control unit 1003.

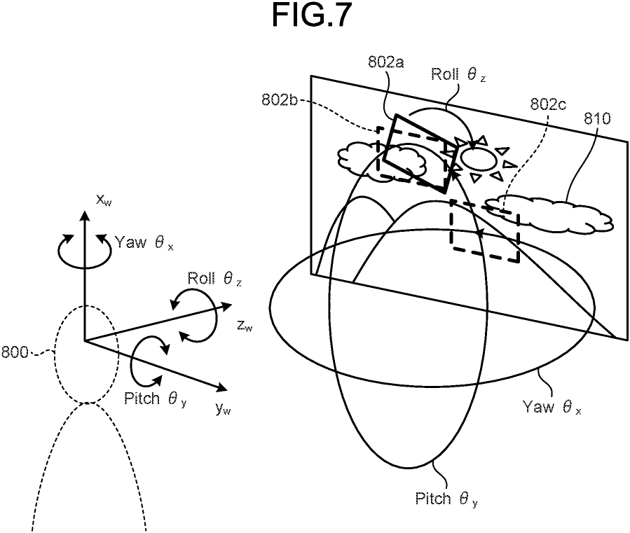

FIG. 7 is a schematic diagram for describing a mechanism for displaying the virtual object so that the AR glasses 10 follow the motion of the head of the user, which is applicable to each embodiment. In FIG. 7, an axis indicating a depth direction of the line-of-sight of the user 800 is an axis z_{w}, a horizontal axis is an axis y_{w}, and a vertical axis is an axis x_{w}, and an origin position of a reference axis x_{w}y_{w}z_{w} of the user is a viewpoint position of the user. Roll (roll) θ_{z} corresponds to a motion about the axis z_{w} axis of the head of the user, pitch (pitch) θ_{y} corresponds to a motion about the axis y_{w} axis of the head of the user, and yaw (yaw) θₓ corresponds to a motion about the axis x_{w} axis of the head of the user.

The head position/posture detection unit 1002 detects posture information including motions (θ_{z}, θ_{y}, θₓ) of the head of the user 800 in the roll, pitch, and yaw directions and parallel movement of the head based on the sensor signals of the posture sensor 1104, the acceleration sensor 1105, and the azimuth sensor 1106. The output control unit 1003 moves a display field angle of the display unit 1201 with respect to the real space in which the virtual object is arranged so as to follow the posture of the head of the user 800, and displays the image of the virtual object existing at the display field angle on the display unit 1201.

As a more specific example, the output control unit 1003 moves the display field angle so as to cancel the motion of the head of the user by rotation according to the Roll component (θ_{z}) of the head movement of the user 800 with respect to a region 802a, movement according to the Pitch component (θ_{y}) of the head movement of the user 800 with respect to a region 802b, movement according to the Yaw component (θₓ) of the head movement of the user 800 with respect to a region 802c, and the like. As a result, the virtual object arranged at the display field angle moved following the position and posture of the head of the user 800 is displayed on the display unit 1201, and the user 800 can observe the real space on which the virtual object is superimposed through the AR glasses 10.

The function of the control unit 100 will be described with reference to FIG. 5 again. The finger position/posture detection unit 1004 detects the position and posture of the hand 21 and the finger of the user wearing the AR glasses 10 based on the recognition result of the image photographed by the outward camera 1101 or each sensor signal output from each of the IMUs 201 to 203 of the hand sensor 20. The finger gesture detection unit 1005 detects a gesture by the finger of the user wearing the AR glasses 10 based on the recognition result of the image photographed by the outward camera 1101 or each sensor signal output from each of the IMUs 201 to 203 of the hand sensor 20. Here, the gesture of the finger includes a form in which the finger is taken, specifically, the angles of the MP joint and the PIP joint of the second finger, the presence or absence of contact between the fingertip of the first finger and the fingertip of the second finger, and the like.

That is, in the AR glasses 10, the control unit 100 functions as an acquisition unit that acquires, by the finger position/posture detection unit 1004, motion information indicating the motion of the user wearing the AR glasses 10 based on each sensor signal output from the hand sensor 20 and the image captured by the outward camera 1101.

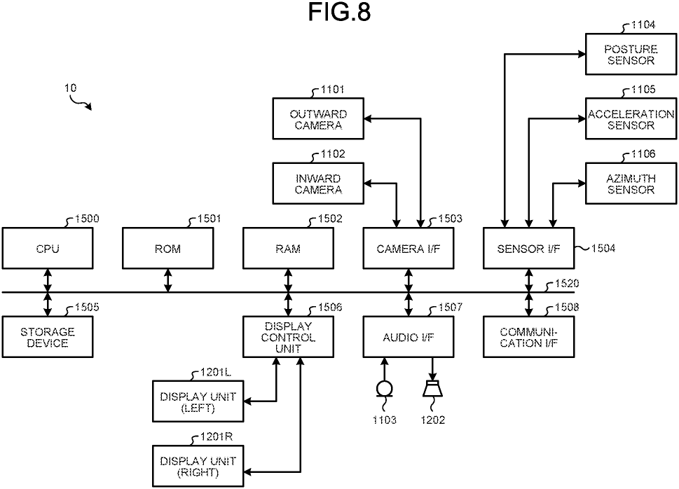

FIG. 8 is a block diagram illustrating a hardware configuration of an example of the AR glasses 10 applicable to each embodiment. In FIG. 8, the AR glasses 10 include a CPU 1500, a read only memory (ROM) 1501, a random access memory (RAM) 1502, a camera interface (I/F) 1503, a sensor I/F 1504, a storage device 1505, a display control unit 1506, an audio I/F 1507, and a communication I/F 1508 which are communicably connected to each other by a bus 1520. As described above, the AR glasses 10 have a configuration as a computer (information processing apparatus) including a CPU, a memory, and various I/Fs.

The storage device 1505 is a nonvolatile storage medium such as a flash memory, and implements the function of the storage unit 140 described with reference to FIG. 3. The CPU 1500 operates using the RAM 1502 as a work memory according to an information processing program stored in advance in the storage device 1505 or the ROM 1501, and controls the entire operation of the AR glasses 10.

The camera I/F 1503 is an interface for the outward camera 1101 and the inward camera 1102, and supplies image signals output from the outward camera 1101 and the inward camera 1102 to the bus 1520. In addition, a control signal for controlling the outward camera 1101 and the inward camera 1102, which is generated by the CPU 1500 according to the information processing program, is transmitted to the outward camera 1101 and the inward camera 1102 via the camera I/F 1503.

The sensor I/F 1504 is an interface for the posture sensor 1104, the acceleration sensor 1105, and the azimuth sensor 1106, and the sensor signals output from the posture sensor 1104, the acceleration sensor 1105, and the azimuth sensor 1106 are supplied to the bus 1520 via the sensor I/F 1504.

The display control unit 1506 controls display operation by the display units 1201L and 1201R in accordance with a command from the CPU 1500. For example, the display control unit 1506 converts a display control signal generated by the CPU 1500 according to the information processing program into a display signal displayable by the display units 1201L and 1201R, and supplies the display signal to the display units 1201L and 1201R.

The audio I/F 1507 is an interface for the microphone 1103 and the sound output unit 1202. For example, the audio I/F 1507 converts an analog sound signal based on the sound collected by the microphone 1103 into a digital sound signal and supplies the digital sound signal to the bus 1520. Furthermore, the audio I/F 1507 converts a signal into a signal in a format that can be reproduced by the sound output unit 1202 based on a digital sound signal generated by the CPU 1500 according to the information processing program and supplied via the bus 1520, for example, and supplies the signal to the sound output unit 1202.

The communication I/F 1508 controls communication between the AR glasses 10 and the hand sensor 20 in accordance with a command from the CPU 1500. Furthermore, the communication I/F 1508 can also control communication with the outside. For example, the communication I/F 1508 controls communication with the server 3 via the network 2 in the AR glass system 1c of FIG. 1C described above.

For example, by executing the information processing program according to each embodiment, the CPU 1500 configures the application execution unit 1001, the head position/posture detection unit 1002, the output control unit 1003, the finger position/posture detection unit 1004, and the finger gesture detection unit 1005 included in the control unit 100 described above on the main storage area of the RAM 1502 as modules, for example. Note that the information processing program can be acquired from the outside (for example, the server 3) via the communication I/F 1508, for example, and can be installed on the AR glasses 10.

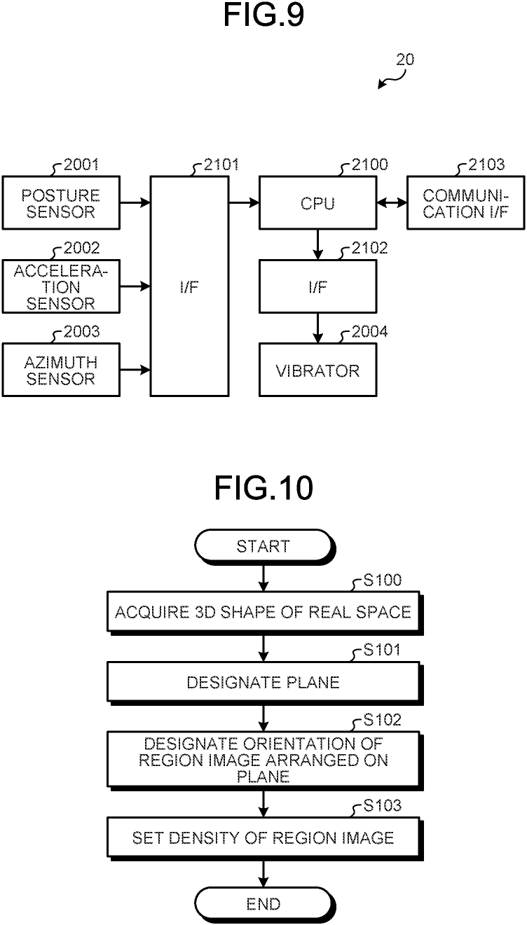

FIG. 9 is a block diagram illustrating a hardware configuration of an example of the hand sensor 20 applicable to each embodiment. In FIG. 9, in the hand sensor 20, interfaces (I/Fs) 2101 and 2102 and a communication I/F 2103 are connected to the CPU 2100. The present invention is not limited thereto, and similarly to the AR glasses 10 described with reference to FIG. 8, the hand sensor 20 may be configured using a bus that communicably connects the respective units. In addition, similarly to the hand sensor 20 illustrated in FIG. 9, the above-described AR glasses 10 can be configured such that each unit is directly connected to the CPU.

In the example of FIG. 9, the CPU 2100 is configured to include a ROM that stores a program for operating itself, and a RAM used as a work memory when the program is executed. Of course, the ROM and the RAM can be connected to the outside of the CPU. The communication I/F 2103 controls communication with the AR glasses 10 according to a command of the CPU 2100.

The I/F 2101 is an interface for the posture sensor 2001, the acceleration sensor 2002, and the azimuth sensor 2003, and sensor signals output from the posture sensor 2001, the acceleration sensor 2002, and the azimuth sensor 2003 are supplied to the CPU 2100 via the I/F 2101. The CPU 2100 transmits the sensor signals supplied from the posture sensors 2001, the acceleration sensor 2002, and the azimuth sensor 2003 from the communication I/F 2103 to the AR glasses 10.

The I/F 2102 is an interface for the vibrator 2004. For example, the I/F 2102 generates a drive signal for driving the vibrator 2004 based on a command issued by the CPU 2100 according to a control signal transmitted from the AR glasses 10 and received by the communication I/F 2103, and supplies the drive signal to the vibrator 2004.

### 3. First Embodiment

Next, a first embodiment of the present disclosure will be described.

### 3-1. Outline of Processing of First Embodiment

First, processing by the AR glasses 10 as the information processing apparatus according to the first embodiment will be schematically described. FIG. 10 is a flowchart schematically illustrating an example of processing by the AR glasses 10 according to the first embodiment. Prior to the execution of the processing of the flowchart of FIG. 10, for example, the user wears the AR glasses 10 and activates the AR glasses 10 by a predetermined operation such as turning on the power of the worn AR glasses 10.

In Step S100, the AR glasses 10 measure a surrounding three-dimensional (3D) shape using an existing technology based on the image captured by the outward camera 1101, for example. For example, the user looks around with the AR glasses 10 worn. Meanwhile, the AR glasses 10 capture images at regular time intervals by the outward camera 1101 and acquire a plurality of captured images obtained by imaging the surroundings. The AR glasses 10 analyze the acquired captured image and measure the surrounding three-dimensional shape. In a case where the outward camera 1101 includes a TOF camera, the AR glasses 10 can obtain surrounding depth information. The AR glasses 10 measure the surrounding three-dimensional shape based on the depth information.

The AR glasses 10 generate a three-dimensional model of the real space based on the measurement result of the surrounding three-dimensional shape. In this case, the AR glasses 10 can generate an independent three-dimensional model based on edge information or the like for the real object arranged in the real space. The AR glasses 10 store data of the three-dimensional model generated based on a result of measuring the surrounding three-dimensional shape in, for example, the storage unit 140.

In the next Step S101, the AR glasses 10 designate a plane based on the operation of the user. More specifically, the AR glasses 10 designate the plane (real surface) in the real space for displaying the real object or the region image indicating the region for arranging the virtual object in the virtual space, and specify the plane related to the display of the region image. In the next Step S102, the AR glasses 10 designate an orientation (azimuth) of the region image to be arranged on the plane designated in Step S101 based on the operation of the user. In the next Step S103, the AR glasses 10 and the density of the region image designated in Step S102 are set.

By the processing of the flowchart of FIG. 10, the user can display the region image with the designated azimuth and density with respect to the surface (virtual surface) in the virtual space corresponding to the real surface in the real space by the AR glasses 10. As a result, the user can easily arrange the real object with respect to the real space. Furthermore, since the region image is displayed in the virtual space by the AR glasses 10, for example, the AR glasses 10 can display the region image for a portion that is hidden with respect to the line-of-sight at the current position by changing the position of the user so that the portion can be seen.

Here, a content of the region image is not limited as long as the region image can indicate the region for arranging the real object or the virtual object. As an example, a grid image indicating a grid obtained by combining a line having the orientation designated by the user in Step S102 and a line having an orientation (for example, an orientation orthogonal to the orientation) different from the orientation can be used as the region image. The region image is not limited to this, and may be a dot indicating each coordinate point of the real surface, or may be an image in which tile images of a predetermined size are arranged on the real surface.

Furthermore, for example, in a case where the region image is a grid or a dot, the density of the region image is an interval between grids or dots. When the region image is a tile image, the tile image size corresponds to the density.

Note that, in the flowchart of FIG. 10, the designation of the plane in Step S101 and the designation of the orientation of the region image in Step S102 are illustrated as independent operations, but this is not limited to this example. For example, the designation of the plane in Step S101 and the designation of the orientation of the region image in Step S102 may be a series of operations. Furthermore, the AR glasses 10 can execute the operation of Step S101 and the operation of Step S102 with, for example, a predetermined gesture by a hand of the user, a predetermined utterance of the user, or the like as a trigger.

In the following description, it is assumed that the region image is the grid image indicating the grid. In addition, the grid image indicating the grid is simply referred to as a “grid”.

### 3-2. Designation Method of Plane

The designation method of the plane in Step S101 in the flowchart of FIG. 10 will be described. Several methods are conceivable for specifying the real surface using the AR glasses 10. Here, a designation method (first designation method of the plane) of performing designation based on the motion of the hand of the user, a designation method (second designation method of the plane) of performing designation using the controller 11 in the configuration of FIG. 1B, a designation method (third designation method of the plane) of performing designation based on the line-of-sight of the user, and a designation method (fourth designation method of the plane) of autonomously performing designation by the AR glasses 10 will be described.

The first designation method of the plane will be described. FIG. 11 is a schematic diagram for describing the first designation method of the plane according to the first embodiment. FIG. 11 illustrates a real space including a floor surface 300 and a wall surface 301, and the hand 21 schematically illustrates a substantial hand (a portion beyond a wrist) of the user wearing the AR glasses 10. Each unit (IMUs 201 to 203) included in the hand sensor 20 and the hand sensor control unit 204 are attached to the hand 21.

The user performs an operation of pointing a plane desired to be designated with fingers of the hand 21. In a case where the user wears the hand sensor 20 on the hand 21, an action of pointing with a finger (second finger in this example) on which the IMUs 202 and 203 are provided is performed. The AR glasses 10 detect the motion of the hand 21 of the user based on each sensor signal transmitted from the hand sensor 20, and designate a plane (floor surface 300) intersecting an instruction destination pointed by the user as the real surface. Not limited to this, the AR glasses 10 can acquire the direction pointed by the finger of the hand 21 based on the captured image obtained by imaging the finger of the hand 21 or the like by the outward camera 1101.

In the example of FIG. 11, an instruction line 310 indicating an instruction destination pointed by the user intersects floor surface 300 at a point 311. In this case, the user is not limited to the operation of designating the point 311, and may move the instruction destination to be pointed, for example, in a plane desired to be designated. In FIG. 11, a range 312 schematically illustrates a range in which the instruction destination is moved by the user in this manner.

In Step S100 in the flowchart of FIG. 10, the three-dimensional shape around the AR glasses 10 has already been measured, and the three-dimensional model has been acquired. In addition, the direction indicated by the instruction line 310 can be obtained based on each sensor signal output from each of the IMUs 201 to 203 of the hand sensor 20. In the AR glasses 10, the control unit 100 can specify the plane (floor surface 300) in the direction pointed by the user, based on the three-dimensional model and the information of the instruction line 310.

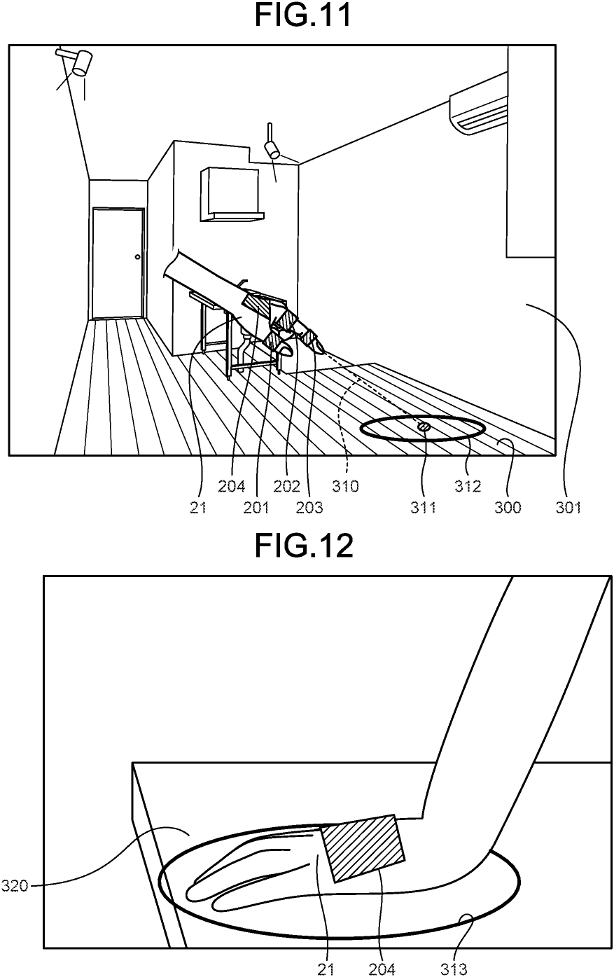

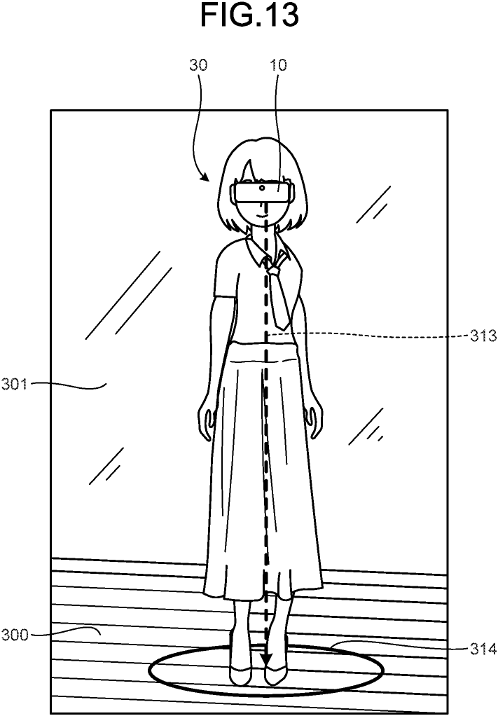

Although the plane is specified remotely in the above description, this is not limited to this example. FIG. 12 is a schematic diagram for describing another example of the first designation method of a plane according to the first embodiment. In the example of FIG. 12, the user moves (strokes) the hand 21 on a plane 320 while keeping the hand 21 in contact with the plane 320 while bringing the hand 21 into contact with the plane 320 (assumed to be a desk surface) to be designated. In FIG. 12, a range 313 schematically illustrates a range in which the user moves the plane 320 while keeping the hand 21 in contact with the plane 320 in this manner. The AR glasses 10 designate, as a real surface, the plane 320 that the user has moved with the hand 21 in contact with.

The second designation method of a plane will be described. In the case of the AR glass system 1b illustrated in FIG. 1B, the real surface can be designated using the beam light emitted from the controller 11. For example, the user points the plane with the beam light using the controller 11. The AR glasses 10 capture an image of an emission destination of the beam light by, for example, the outward camera 1101, and detect a position irradiated with the beam light based on the captured image. Since the three-dimensional model around the AR glasses 10 has already been acquired in Step S100 of the flowchart of FIG. 10, the AR glasses 10 can specify a plane including the city irradiated with the beam light based on the captured image, and can designate the specified plane as the real surface.

The third designation method of a plane will be described. The third designation method of a plane is a designation method of the plane as the real surface based on the line-of-sight direction of the user wearing the AR glasses 10. For example, the AR glasses 10 image an eyeball of the user wearing the AR glasses 10 using the inward camera 1102. The AR glasses 10 detect a line-of-sight (line-of-sight direction) of the user using an existing technology based on a captured image obtained by imaging the eyeball by the inward camera 1102. The AR glasses 10 designate a plane intersecting the line-of-sight as a real surface.

A fourth designation method of a plane will be described. In the fourth designation method of a plane, the AR glasses 10 designate the plane on which the AR glasses 10 are worn and stand as the real surface.

FIG. 13 is a schematic diagram for describing the fourth designation method of a plane according to the first embodiment. In FIG. 13, the user 30 is standing on the floor surface 300 while wearing the AR glasses 10. For example, the AR glasses 10 measure an inclination of the AR glasses 10 themselves based on a sensor signal output from the posture sensor 1104, and obtains the vertical line 314 passing through the AR glasses 10 based on the measurement result. Since the three-dimensional model around the AR glasses 10 has already been acquired in Step S100 of the flowchart of FIG. 10, by detecting a plane (floor surface 300 in the example of FIG. 13) intersecting a vertical line 314, the plane can be designated as the real surface.

Note that the AR glasses 10 can obtain, for example, the vertical line 314 passing through a predetermined position on the AR glasses 10. Not limited to this, the AR glasses 10 can also obtain the vertical line 314 passing through the position estimated to be the center of the head where the AR glasses 10 are roughly attached.

### 3-3. Designation Method of Orientation of Region Image

A designation method of the orientation (azimuth) in the real space of the region image displayed in the virtual space corresponding to the plane of the real space designated in Step S101 in Step S102 in the flowchart of FIG. 10 will be described. There are several possible designation methods for designating the orientation of the region image in the real space using the AR glasses 10. Here, a designation method (first designation method of orientation) of performing designation based on the motion of the hand of the user, a designation method (second designation method of orientation) of performing designation using the controller 11 in the configuration of FIG. 1B, and a designation method (third designation method of orientation) of autonomously performing designation using the AR glasses 10 will be described.

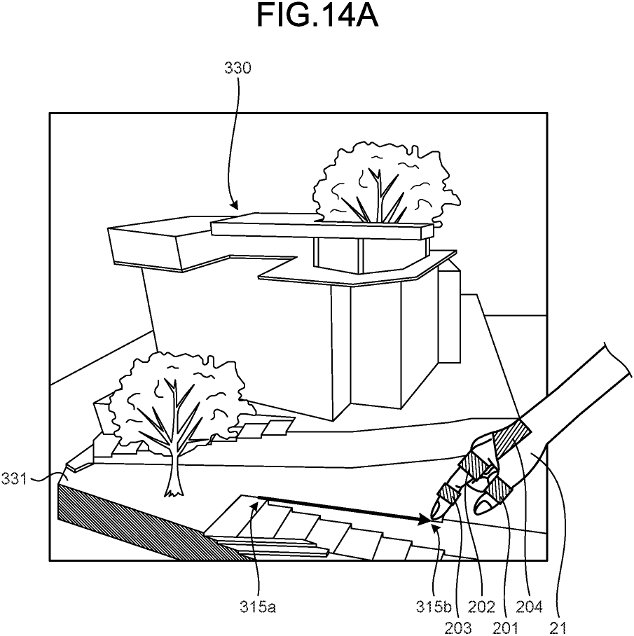

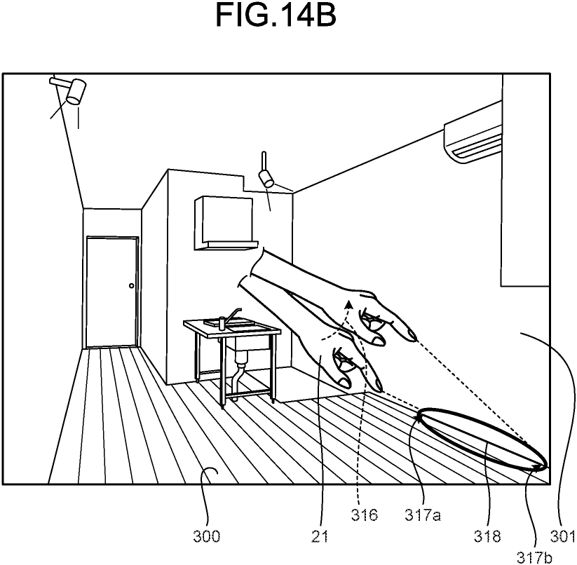

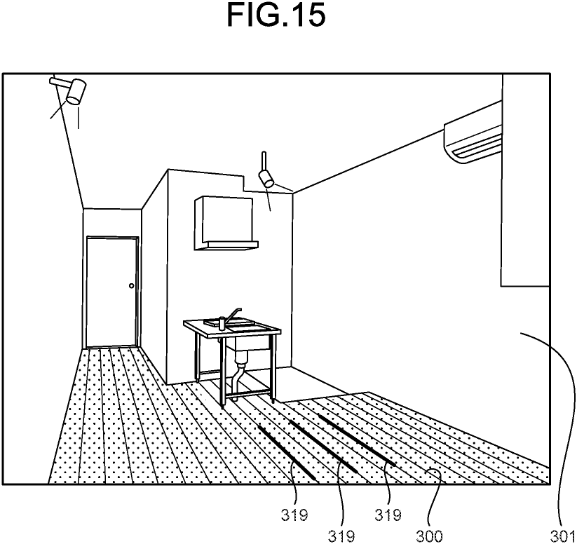

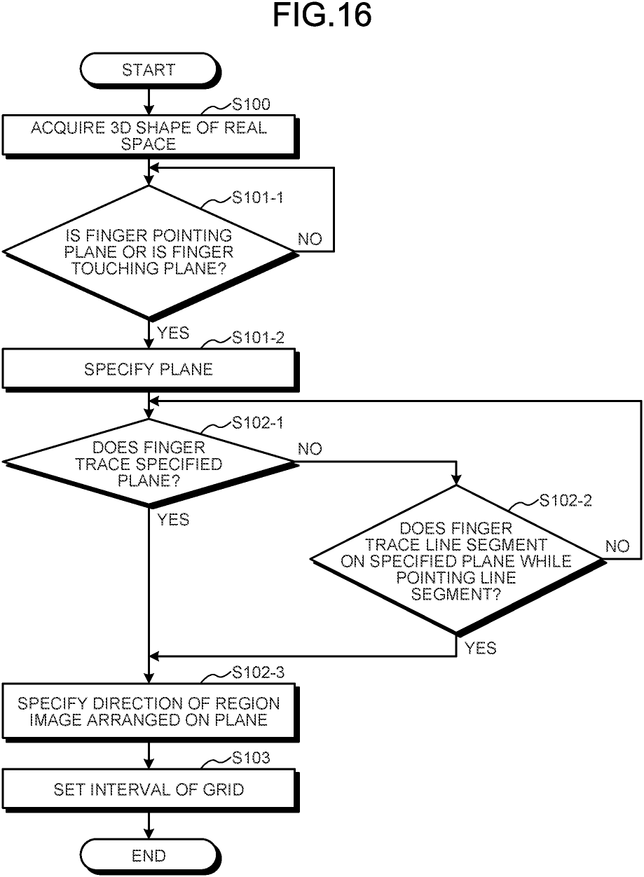

The first designation method of the orientation will be described. FIGS. 14A and 14B are schematic diagrams for describing the first designation method of the orientation according to the first embodiment. FIG. 14A schematically illustrates an example in a case where a plane 331 corresponding to the ground in a building model 330 is designated as the real surface in Step S101 of the flowchart of FIG. 10. As described above, the AR glasses 10 according to the first embodiment are not limited to a real object such as a building, and it is also possible to designate a real surface for a model or the like.

In FIG. 14A, the user moves a finger (second finger in this example) of the hand 21 on which the IMUs 202 and 203 are worn in the hand sensor 20 in a direction in which the user wants to set the orientation of the region image while pointing the plane 331. In the example of FIG. 14A, the user moves the finger from point 314a to point 314b of plane 331. That is, the user moves the finger from the point 314a to point 314b on plane 331 so as to trace the plane 331. The AR glasses 10 designate a direction along a line segment connecting the point 314a and the point 314b as the orientation of the region image.

FIG. 14B is a diagram schematically illustrating another example of the first designation method of the orientation. Another example of the first designation method of this orientation is an example of designating the orientation of the region image using the feature portion on the real surface. The feature portion on the plane is not particularly limited as long as the feature portion is linear, but a case where the orientation of the region image is designated using a boundary 318 between the floor surface 300 and the wall surface 301 will be described below.

In the example of FIG. 14B, the user first points a point 317a on the boundary 318 between the floor surface 300 and the wall surface 301 by the finger (second finger in this example) of the hand 21 on which the IMUs 202 and 203 in the hand sensor 20 are worn. The user further moves the hand 21 as indicated by an arrow 316 in the drawing, for example, to move the hand from the point 317a toward a point 317b while pointing the boundary 318 so as to trace the boundary 318 at the pointing point. The AR glasses 10 designate the direction along the boundary 318 as the orientation of the region image based on the line segment connecting the point 317a and the point 317b.

This is not limited to this example, and the AR glasses 10 can detect the motion in which the position pointed by the hand 21 moves from the point 317a to the point 317b based on the captured image obtained by imaging the hand 21 by the outward camera 1101, and can designate the direction along the boundary 318 as the orientation of the region image based on the line segment connecting the point 317a and the point 317b.

In this manner, in a case where the orientation of the region image is designated using the feature portion on the real surface, a margin can be provided for the position pointed by the user. For example, in the case of using the hand sensor 20, even when the pointing position includes a slight deviation from the boundary 318, it can be regarded that a point on the boundary 318 existing in the vicinity of the pointing position is designated based on the three-dimensional model acquired in Step S100, for example. This also applies to a case where the image captured by the outward camera 1101 is used.

The second designation method of the orientation will be described. In the case of the AR glass system 1b illustrated in FIG. 1B, the orientation of the region image can be designated using the beam light emitted from the controller 11. For example, the user uses the controller 11 to linearly move the irradiation position of the beam light while pointing the plane with the beam light. The AR glasses 10 image an irradiation position of the beam light by, for example, the outward camera 1101, and detect a trajectory irradiated with the beam light based on the captured image. The AR glasses 10 designate the orientation of the region image based on the detection result of the trajectory. This is also applicable to the example of designating the orientation of the region image using the feature portion on the real surface described with reference to FIG. 14B.

The third designation method of the orientation will be described. The third designation method of the orientation is an example of designating the orientation of the region image based on the pattern on the plane of the real space designated in Step S101.

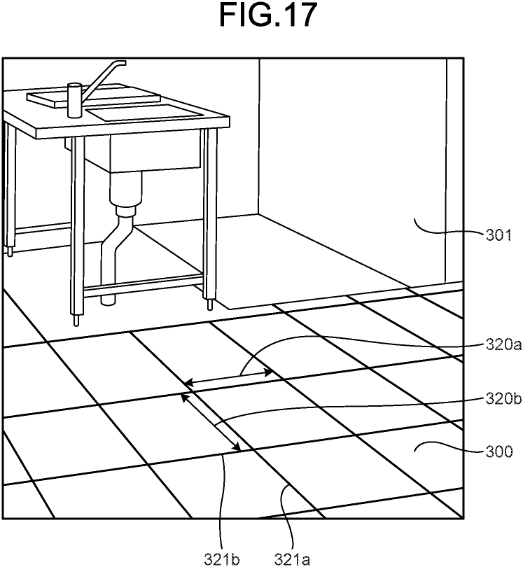

FIG. 15 is a schematic diagram for describing the third designation method of the orientation according to the first embodiment. The AR glasses 10 image the plane (the floor surface 300 in this example) designated by the outward camera 1101, and detect a pattern included in the captured image and aligned in a certain direction on the plane. The pattern can be detected based on, for example, feature information extracted from the captured image. In FIG. 15, the AR glasses 10 detect mating marks 319, 319,... of boards on the floor surface 300 of the flooring as patterns based on the captured image, and extract the orientations of the detected patterns. The orientation of the extracted pattern is designated as the orientation of the region image.

In the example of FIG. 15, the pattern is illustrated as being flooring-like in which a length of a long side is extremely longer than a length of a short side, but this is not limited to this example. For example, the pattern may be a tile-like pattern in which a ratio between the length of the long side and the length of the short side is small, or may be a pattern in which elements partially including a straight line or not including a straight line at all are aligned in a straight line.

In addition, it is also possible to use an edge of a designated plane as the pattern on the plane of the real space. For example, the AR glasses 10 detect the edge of the plane (floor surface 300) designated in Step S100 based on the image captured by the outward camera 1101 or the three-dimensional model of the real space generated in Step S101. When the plane is the floor surface 300, the boundary 318 between the floor surface 300 and the wall surface 301 illustrated in FIG. 14B can be applied to the edge.

### 3-4. Designation Method of Density of Region Image

A method of setting the density of the region image designated in Step S102 in Step S103 in the flowchart of FIG. 10 will be described. The density of the region image is a grid interval when the region image is a grid. Similarly, in a case where the region image is a dot, the density is an interval between dots, and in a case where the region image is a tile image, the density is a size of the tile image.

The AR glasses 10 can set the density of the region image based on a default value that the system has in advance. Not limited to this, the AR glasses 10 can set the density of the region image, for example, according to a user operation by the user wearing the AR glasses 10. As an example, the AR glasses 10 display an operation menu using the display units 1201L and 1201R or on the display screen of the controller 11 in the case of using the controller 11. The user operates the operation menu with a gesture, a voice, an operator, or the like to set the density of the region image.

FIG. 16 is a flowchart illustrating an example of processing in a case where the above-described designation of the plane and designation of the orientation of the region image are executed by a series of motions of the hand 21 (finger) according to the first embodiment. Note that the AR glasses 10 execute the motion of the hand 21 of the user, the detection of the direction in which the finger points, and the like based on each sensor signal output from the hand sensor 20 or the image captured by the outward camera 1101.

Step S100 is the processing corresponding to Step S100 in the flowchart of FIG. 10 described above, and the AR glasses 10 measure the surrounding three-dimensional shape based on, for example, the image captured by the outward camera 1101 to acquire the three-dimensional model.

Next Steps S101-1 and S101-2 correspond to the processing of Step S101 of the flowchart of FIG. 10 described above. In Step S101-1, the AR glasses 10 determine whether or not the hand 21 (finger) is performing any one of the operation (see FIG. 11) of pointing the plane in the real space and the operation of touching the plane in the real space with the hand 21 (see FIG. 12). In a case where it is determined that neither the operation in which the hand 21 points the plane in the real space nor the operation in which the hand 21 touches the plane in the real space is executed (Step S101-1, “No”), the AR glasses 10 returns the processing to Step S101-1.

Meanwhile, in a case where the AR glasses 10 determine in Step S101-1 that either the operation in which the hand 21 points the plane in the real space or the operation in which the hand 21 touches the plane in the real space is executed (Step S101-2, “Yes”), the processing proceeds to Step S101-2. In Step S101-2, the AR glasses 10 specifies the plane pointed by the hand 21 or the plane touched by the hand 21 in Step S101-1 as the plane of the real space corresponding to the plane on which the region image in the virtual space is displayed.

The processing proceeds to the next Step S102-1. This Step S102-1 and the following Steps S102-2 and S102-3 correspond to the processing of Step S102 of the flowchart of FIG. 10 described above.

In Step S102-1, the AR glasses 10 determine whether or not the hand 21 (finger) traces the plane specified in Step S101-2. The AR glasses 10 determine that the hand traces the plane in a case where the hand 21 is moved linearly while a state where the hand 21 points the plane or in a state where the hand 21 touches the plane in Step S101-1 is maintained. When the AR glasses 10 determine that the plane is traced by the hand 21 (Step S102-1, “Yes”), the processing proceeds to Step S102-3.

Meanwhile, when the AR glasses 10 determine that the plane is not traced by the hand 21 (Step S102-1, “No”), the processing proceeds to Step S102-2. In Step S102-2, the AR glasses 10 determine whether the hand 21 traces (linearly moves) the line segment on the plane specified in Step S101-2 while pointing the line segment. When the AR glasses 10 determine that the operation of tracing the line segment while pointing the line segment is not executed by the hand 21 (Step S102-2, “No”), the processing returns to Step S102-1.

In a case where the AR glasses 10 determine that the operation of tracing the line segment while pointing the line segment is executed in Step S102-2, the processing proceeds to Step S102-3.

In Step S102-3, the AR glasses 10 specifies the direction in which the hand 21 traces the plane in Step S102-1 or Step S102-2 as the direction (azimuth) of the region image to be displayed on the plane in the virtual space corresponding to the plane of the real space specified in Step S101-2.

When the orientation (azimuth) in which the region image is displayed is specified in Step S102-3, the processing proceeds to Step S103, and the density of the region image is set similarly to Step S103 of the flowchart of FIG. 10 described above.

In this manner, the AR glasses 10 can execute the identification of the plane in the virtual space for displaying the region image and the orientation of the region image to be displayed on the plane in the identified virtual space based on a series of motions of the hand 21 of the user. As a result, the user can easily display the region image on the plane in the virtual space corresponding to the plane in the real space.

### 3-5. Specific Example of Region Image

Next, a display example of the region image applicable to the first embodiment will be described. Note that, here, the description will be given assuming that the region image is a grid.

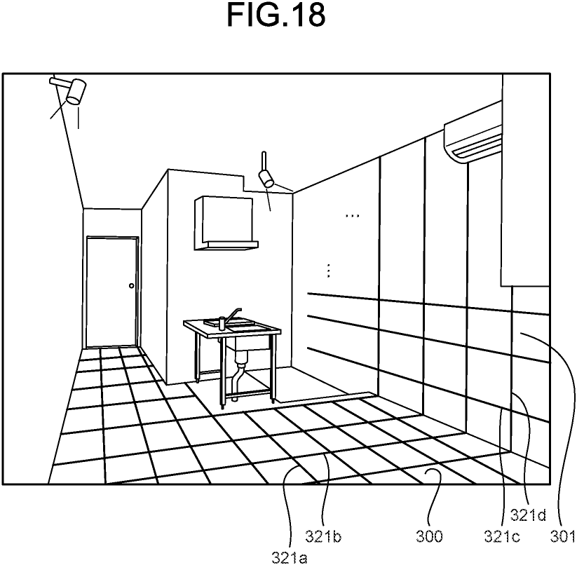

FIG. 17 is a schematic diagram illustrating a specific example of the display of the region image applicable to the first embodiment. The example of FIG. 17 is an example in which the floor surface 300 is designated as the real surface, and a direction along the boundary 318 (not illustrated) between the floor surface 300 and the wall surface 301 is designated as the orientation of the region image. A region image as a grid is displayed in the virtual space by each of one or more grid lines 321a in a direction along the boundary 318 and each of one or more grid lines 321b along an orientation (for example, an orientation orthogonal to the grid line 321a) different from the grid line 321a. An interval 320a of each grid line 321a and an interval 320b of each grid line 321b are grid intervals corresponding to the density of the region image set in the processing of Step S13 in the flowchart of FIG. 10.

In the example of FIG. 17, the grid is displayed only on the virtual surface corresponding to the floor surface 300 designated as the real surface, but this is not limited to this example. For example, it is possible to additionally designate another surface (for example, the wall surface 301) as the real surface. In this case, a grid is displayed on each virtual surface corresponding to each of the floor surface 300 and the wall surface 301.

In addition, it is also possible to expand a virtual surface on which the grid is displayed. In this case, for example, the AR glasses 10 can display the grid displayed on the virtual surface corresponding to the designated real surface by extending the grid to a virtual surface corresponding to another real surface.

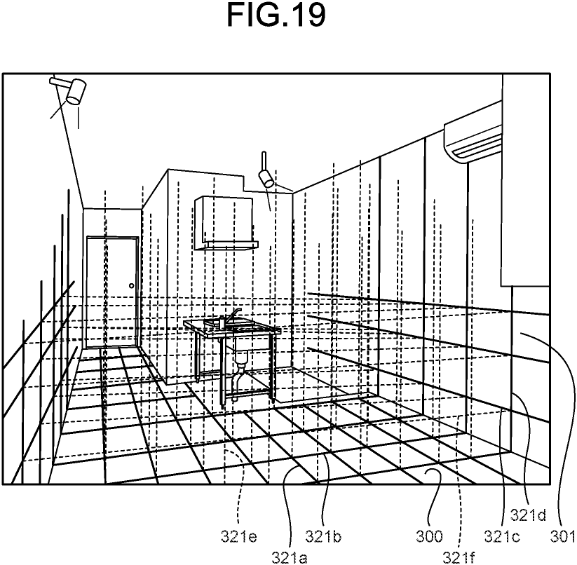

FIG. 18 is a schematic diagram illustrating an example in which a grid is expanded and displayed, which is applicable to the first embodiment. In the example of FIG. 18, the grid is expanded and displayed over the entire virtual space. That is, in FIG. 18, the grid displayed on the virtual surface corresponding to the floor surface 300 is expanded and displayed on the virtual surface corresponding to the wall surface 301 connected to the floor surface 300. More specifically, a grid including a horizontal grid line 321c and a vertical grid line 321d is further displayed on the virtual surface corresponding to the wall surface 301. In this example, the vertical grid line 321d is displayed as a line continuous with the grid line 321b constituting the grid displayed on the virtual surface corresponding to the floor surface 300. The horizontal grid line 321c is displayed in parallel with the grid line 321a. As a result, the user can easily confirm, for example, consistency in arrangement between the floor surface 300 and the wall surface 301.

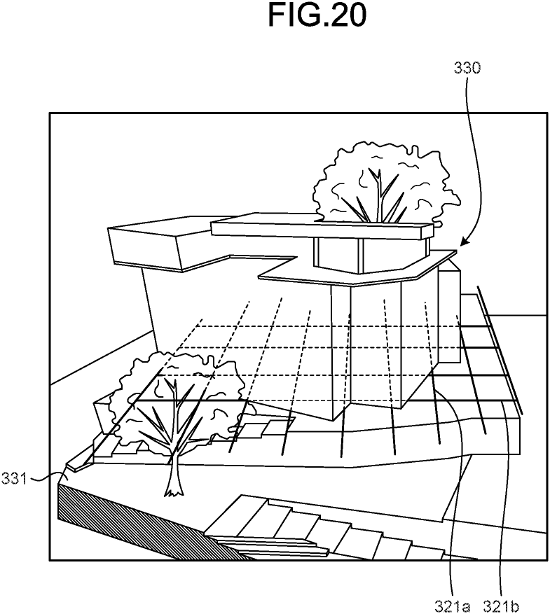

As another example of expanding and displaying the grid in the entire virtual space, it is also possible to display the grid in the entire virtual space. FIG. 19 is a schematic diagram illustrating an example in which a grid is expanded and displayed in the entire virtual space, which is applicable to the first embodiment. In FIG. 19, each grid line 321e is displayed perpendicularly to the virtual surface from each grid point of the grid displayed on the virtual surface corresponding to the floor surface 300, and each grid line 321f is displayed perpendicularly to the virtual surface from each grid point of the grid displayed on the virtual surface corresponding to the wall surface 301. As a result, the stereoscopic lattice corresponding to the orientation designated in Step S102 of the flowchart of FIG. 10 is displayed with respect to the virtual space. As a result, the user can easily confirm, for example, the spatial arrangement.

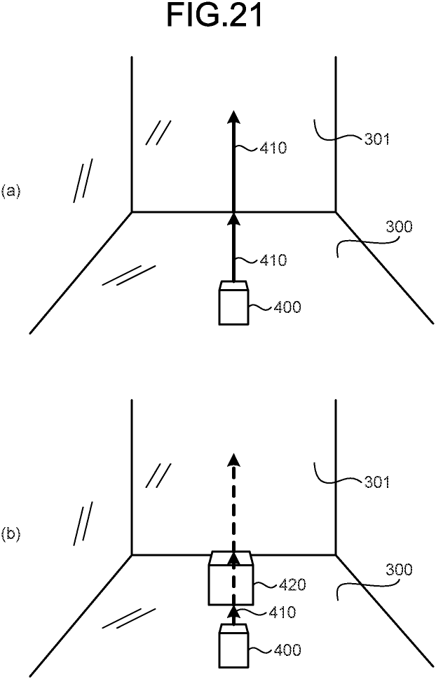

In addition, it is also possible to display the grid on the virtual surface corresponding to the designated real surface on the building model 330 or the like described with reference to FIG. 14A. FIG. 20 is a diagram corresponding to FIG. 14A described above, and is a diagram schematically illustrating an example in which the grid is displayed on the virtual surface corresponding to the real surface designated in the building model 330, applicable to the first embodiment. In FIG. 20, for example, the grid including the grid lines 321a and 321b orthogonal to each other is displayed with respect to a virtual surface corresponding to the plane 331 corresponding to the ground in the building model 330 designated as the real surface. In FIG. 20, the grid of a portion hidden by the building model 330 is indicated by a dotted line. The user can easily arrange each object with respect to the plane 331 by referring to this grid.

### 3-6. Comparison With Existing Technology

Next, effects of the technology according to the first embodiment will be described in comparison with the existing technology. FIG. 21 is a diagram schematically illustrating an example of a case where a line indicating a vertical surface is projected on a surface of a real space using laser light according to the existing technology. In a section (a) of FIG. 21, a trajectory 410 of laser light emitted from a laser light projection device 400 (for example, laser marking device of Patent Literature 1) installed on the floor surface 300 is projected from the floor surface 300 to the wall surface 301.

A section (b) in FIG. 21 illustrates an example in which an object 420 serving as a shielding object exists on the optical path of the laser light by the laser light projection device 400 in the state of the section (a) described above. The laser light emitted from the laser light projection device 400 is blocked by the object 420 and does not reach the back side of the object 420 as viewed from the laser light projection device 400. Therefore, this existing technology may not sufficiently function in a state where the object 420 is already installed on the floor surface 300 on which the laser light projection device 400 is installed.

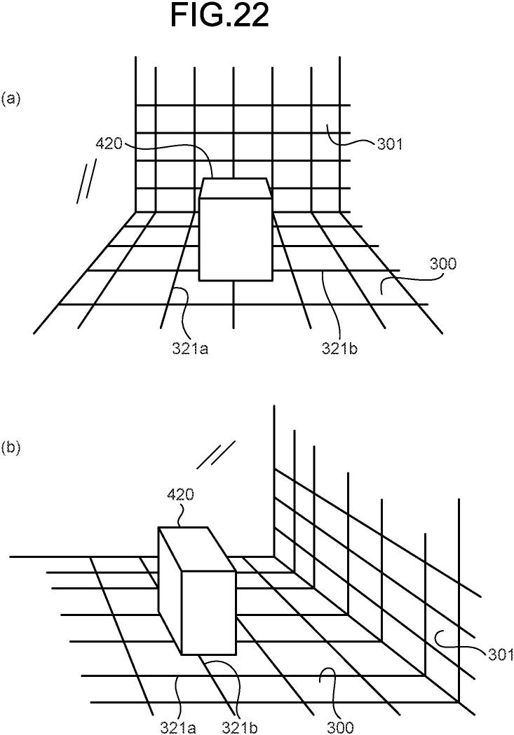

FIG. 22 is a diagram schematically illustrating an example of a case where the grid is displayed in the virtual space according to the first embodiment. Note that, in sections (a) and (b) of FIG. 22, it is assumed that the user wearing the AR glasses 10 is on the lower side of each drawing, that is, on the front side in the depth direction of the drawing, and looks at the back side from the front side.

The section (a) in FIG. 22 schematically illustrates a state in which the grids including the grid lines 321a and 321b are displayed on the virtual surface corresponding to the floor surface 300. In this example, the floor surface 300 between the object 420 and the wall surface 301 and the portion of the wall surface 301 on the back side of the object 420 corresponding to the object 420 are hidden behind the object 420 with respect to the current position of the user. From the current position, the user cannot see the grid in the shaded portion of this object.

Here, in the case of the technology according to the first embodiment, the grid is displayed in the virtual space by the display units 1201L and 1201R of the AR glasses 10. Therefore, by moving to another position around the object 420, the user can see the grid at the position that was hidden by the object 420 in the initial position. More specifically, as illustrated in the section (b) of FIG. 22, when the user goes around to the back side (between the object 420 and the wall surface 301) of the object 420 from the position in the section (a) of FIG. 22, the grid of a portion that has been in the shadow of the object 420 in the section (a) is displayed in the virtual space, and the user can see the grid.

### 4. Second Embodiment

Next, a second embodiment of the present disclosure will be described. A second embodiment relates to display in the virtual space when the real object is arranged in the real space corresponding to the virtual space in which a grid is displayed in the virtual space using the technology of the first embodiment described above.

FIG. 23 is a diagram schematically illustrating a state in which real objects 430a, 430b, and 430c are arranged in the real space in which grids are displayed on the virtual surface corresponding to the real surface in the virtual space as in FIG. 18 described above. Here, it is assumed that each of the real objects 430a, 430b, and 430c has a shape having no straight side on the ground contact surface with respect to the floor surface 300, such as a column shape or an elliptic column shape. For example, when the ground contact surface of the object arranged on the floor surface 300 has a shape having a straight side such as a rectangular parallelepiped, it is easy to arrange the object along the grid.

However, in a case where the ground contact surface with the floor surface 300 has a shape having no straight side as in each of the real objects 430a, 430b, and 430c illustrated in FIG. 23, it is difficult to understand which portion of each of the real objects 430a, 430b, and 430c is to be matched with the grid. Therefore, for example, it is difficult to accurately arrange the real objects 430a, 430b, and 430c in the same orientation.

Therefore, the AR glasses 10 according to the second embodiment can measure the feature amount of the real object to be arranged and acquire the position and posture of the real object based on the measured feature amount. Furthermore, the AR glasses 10 according to the second embodiment set the origin and coordinates on the real object based on the acquired position and posture. Then, a coordinate space represented by the set origin and coordinates is displayed in the virtual space.

### 41. Display of Coordinate Space in Virtual Space

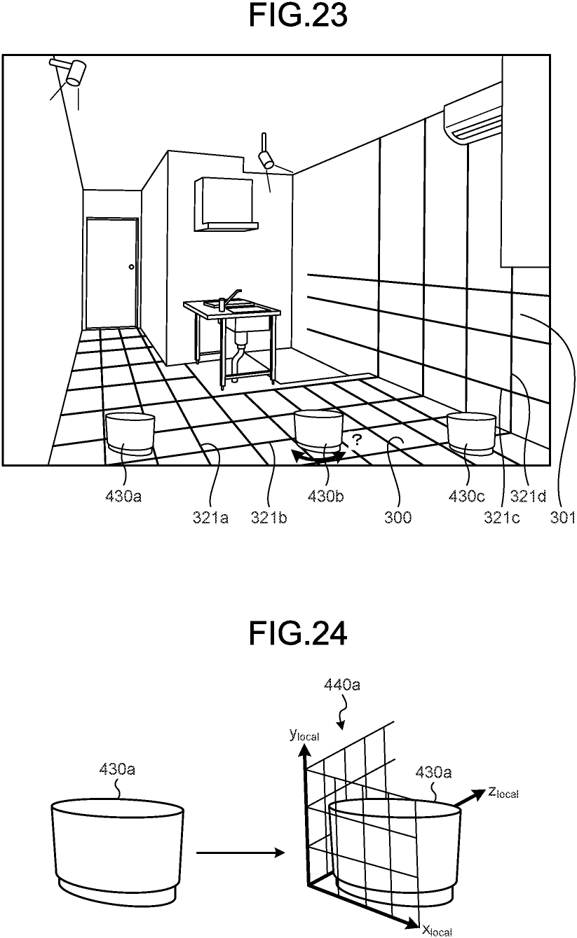

FIG. 24 is a diagram illustrating an example of a coordinate space 440a including an origin and three-dimensional coordinates (x_{local}, y_{local}, z_{local}) set according to the position and posture acquired based on the feature amount with respect to the real object 430a according to the second embodiment. The AR glasses 10 display the coordinate space 440a in the virtual space in association with the position and posture of the real object 430a in the real space. The coordinate space 440a is made available as a guide of the position and posture of the real object 430a when the user arranges the real object 430a on the grid.

As an example of acquiring the position and posture of the real object 430a, a first method will be described The AR glasses 10 measure the shape and texture of the real object 430a. For example, the AR glasses 10 first identify the real object 430a that the user is touching the hand 21. In this case, the AR glasses 10 may specify the real object 430a based on each sensor signal output from the hand sensor 20 or based on the captured image obtained by imaging the hand 21 by the outward camera 1101.

Next, the AR glasses 10 capture an image of the specified real object 430a by, for example, the outward camera 1101, three-dimensionally model the real object 430a in real time based on the captured image, and acquire a three-dimensional model. In addition, the AR glasses 10 set a certain posture (for example, a posture at the time of performing three-dimensional modeling) of the real object 430a in a state where Roll, Pitch, and Yaw are each “0”. The AR glasses 10 register information indicating the three-dimensional model and the posture acquired in this manner for the real object 430a. For example, the AR glasses 10 store the information for identifying the real object 430a and the information indicating the three-dimensional model and the posture of the real object 430a in the storage unit 140 in association with each other.

FIG. 25 is a diagram schematically illustrating an example in which coordinate spaces 440a, 440b, and 440c are displayed in association with real objects 430a, 430b, and 430c arranged in the real space in the virtual space, respectively, according to the second embodiment. The coordinate spaces 440a, 440b, and 440c are displayed at positions and orientations corresponding to the positions and postures specified for the corresponding real objects 430a, 430b, and 430c, respectively. That is, each of the coordinate spaces 440a, 440b, and 440c is a coordinate space based on the local coordinate system for each of the real objects 430a, 430b, and 430c.

In addition, the AR glasses 10 constantly measure the feature amount of the real object 430a and compare the feature amount with the shape indicated by the registered three-dimensional model of the real object 430a to specify the current position and posture of the real object 430a. It is preferable that the AR glasses 10 update the display of the coordinate space 440a based on the information on the position and posture of the real object 430a specified in this way.

Note that the coordinate system of the virtual space and the coordinate system of the coordinate space can be associated with each other by, for example, matrix calculation using known rotation and translation.

As described above, in the second embodiment, the AR glasses 10 acquire the origin and the coordinates based on the position and the posture for each real object arranged in the real space, and set the coordinate space for each real object based on the acquired origin and coordinates. Therefore, the user can easily arrange a real object having a shape in which it is difficult to visually specify the position and posture in the real space in accordance with the grid displayed in the virtual space.

As another example of acquiring the position and posture of the real object 430a, a second method will be described. In this other example, the texture of a part of the real object 430a is regarded as a marker such as an AR marker, and the position and posture of the marker are detected to detect the position and posture of the real object 430a. For example, the AR glasses 10 image the real object 430a by the outward camera 1101, and detect the texture of the real object 430a based on the captured image. A part of the detected texture is extracted, and the extracted part is used as a marker.

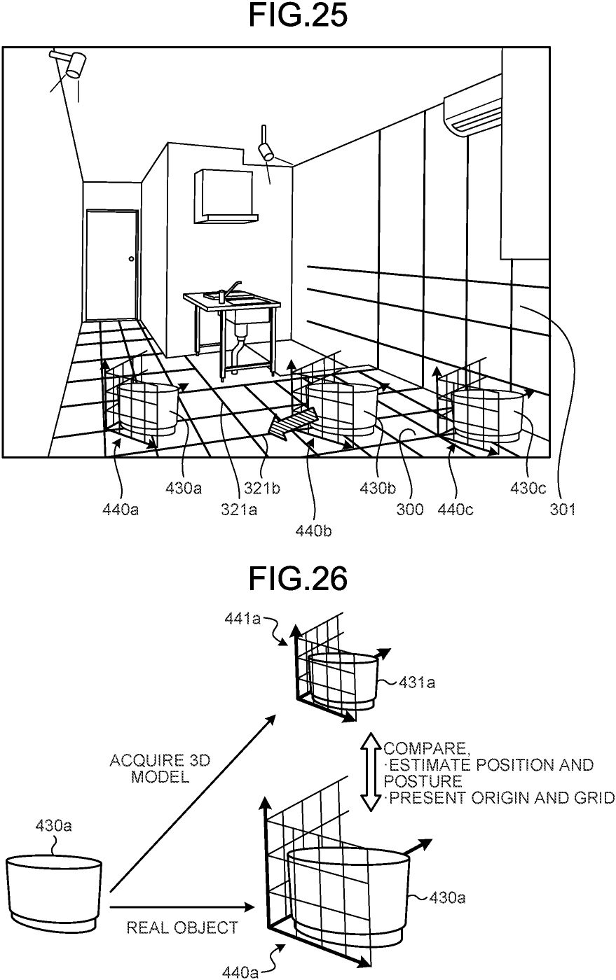

As still another example of acquiring the position and posture of the real object 430a, a third method will be described. FIG. 26 is a schematic diagram for describing still another example of acquiring the position and posture of the real object 430a according to the second embodiment. In the third method, in the AR glass system 1c described with reference to FIG. 1C, the AR glasses 10 may transmit the feature amount measured based on the captured image obtained by imaging the real object 430a to the server 3, and download a three-dimensional model 431a corresponding to the feature amount from the server 3. In the three-dimensional model 431a, a coordinate space 441a is associated with the three-dimensional model 431a in a one-to-one relationship.

The AR glasses 10 can specify the current position and posture of the real object 430a by comparing the three-dimensional model 431a downloaded from the server 3 with the real object 430a.

### 42. Processing on Real Object Partially Deformed

Next, processing on a partially deformed real object will be described. Examples of the partially deformed real object include a potted plant. In the potted plant, the portion of the pot is not deformed, but the position and posture of the plant itself may change due to wind or the like. Therefore, when the real object arranged in the real space is the potted plant, it is preferable not to use the portion of the plant for detection of the position and posture.

FIG. 27 is a schematic diagram for describing a method of setting a coordinate space 440 d for a partially deformed real object according to the second embodiment. In the example of FIG. 27, a potted plant is applied as an example of a partially deformed real object 450. In the real object 450, a pot portion 451 has a fixed shape, while a plant portion 452 swings and changes its shape due to wind, vibration, or the like.

For example, the user wears the AR glasses 10 and traces the pot portion 451 having a fixed shape with the hand 21. In this case, for example, the AR glasses 10 image the entire real object 450 with the outward camera 1101 to detect the motion of the hand 21 of the user, and extracts a portion (pot portion 451) of the real object 450 designated according to the motion of the hand 21 as a detection target of the position and posture. In a case where the user wears the hand sensor 20, the AR glasses 10 may extract the detection target of the position and posture in the real object 450 based on each sensor signal output from the hand sensor 20.

Furthermore, the AR glasses 10 can also perform motion detection processing on a captured image obtained by imaging the real object 450 and extract a motion portion in the real object 450. In this case, a portion other than the extracted motion portion in the real object 450 is extracted as a detection target of the position and posture in the real object 450.

The AR glasses 10 ignore a portion (plant portion 452) of the real object 450 that has not been extracted as a detection target of the position and posture.

The AR glasses 10 measure feature amounts of the pot portion 451 extracted as a detection target of the position and posture of the real object 450 based on the image captured by the outward camera 1101 to acquire the position and posture. The AR glasses 10 sets an origin and coordinates based on the acquired position and posture with respect to the pot portion 451, and displays a coordinate space 44d represented by the set origin and coordinates in the virtual space.

As described above, in the second embodiment, the AR glasses 10 acquire the position and posture ignoring the deformed portion in the real object that is partially deformed. Therefore, the coordinate space can also be set for the real object that is partially deformed, and the real object can be easily arranged in the real space in accordance with the grid displayed in the virtual space.

### 4-1. Modification of Second Embodiment

Next, a modification of the second embodiment will be described. In the second embodiment described above, the coordinate space of the real object is displayed at the position in the virtual space corresponding to the real object arranged in the real space. Meanwhile, in the modification of the second embodiment, the coordinate space is displayed in the virtual space in advance. Then, the real object is moved to a position in the real space corresponding to a position in the virtual space where the coordinate space is displayed, and the real object and the coordinate space are associated with each other.

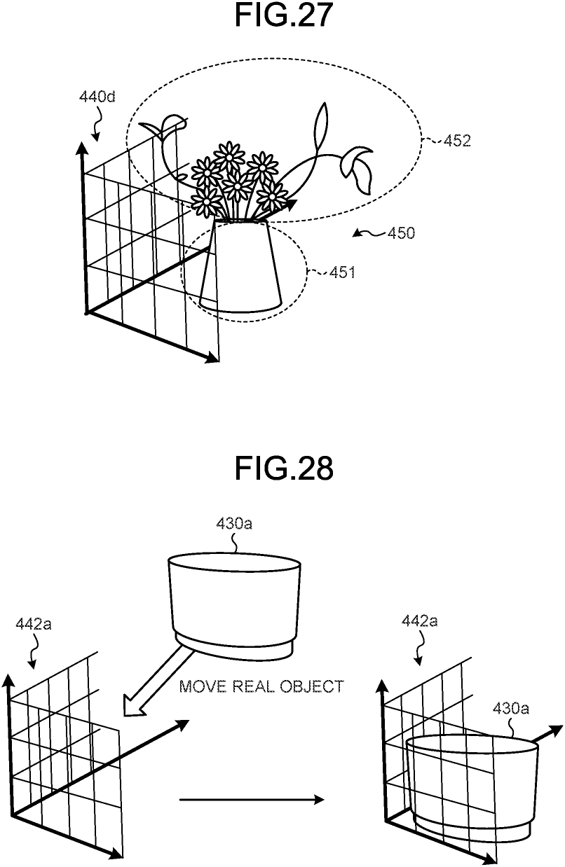

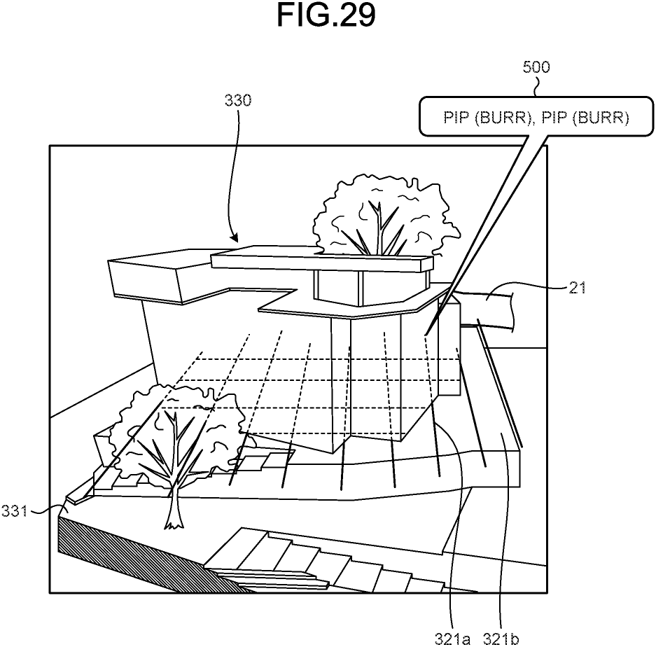

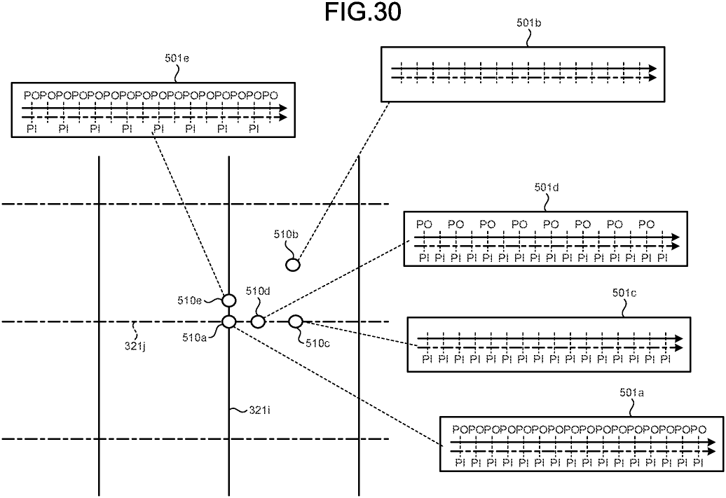

FIG. 28 is a schematic diagram for describing processing of an example according to the modification of the second embodiment. In FIG. 28, first, an origin and coordinates are set at a predetermined position in the virtual space, and a coordinate space 442a is displayed based on the set origin and coordinates. The user actually moves the real object 430a in the real space to the position of the coordinate space 442a based on the coordinate space 442a superimposed and displayed on the real space on the display unit 1201 of the AR glasses 10.

When the user moves the real object 430a to a predetermined position in the coordinate space 442a, the user acquires the position and posture of the real object 430a, and registers the real object 430a in association with the coordinate space 442a. The registration of the real object 430a is performed, for example, in accordance with a gesture and utterance of the hand 21 by the user wearing the AR glasses 10, or a predetermined operation on the controller 11 in a case where the AR glasses 10 use the controller 11. In this case, the posture of the real object 430a at the time when the registration is performed can be regarded as a state (initial state) in which Roll, Pitch, and Yaw are each “0”.

### 5. Third Embodiment

Next, a third embodiment of the present disclosure will be described. In the third embodiment, the AR glasses 10 give the user a stimulus to a sound or a tactile sense according to a positional relationship between the position of the hand 21 of the user wearing the AR glasses 10 and the region image.

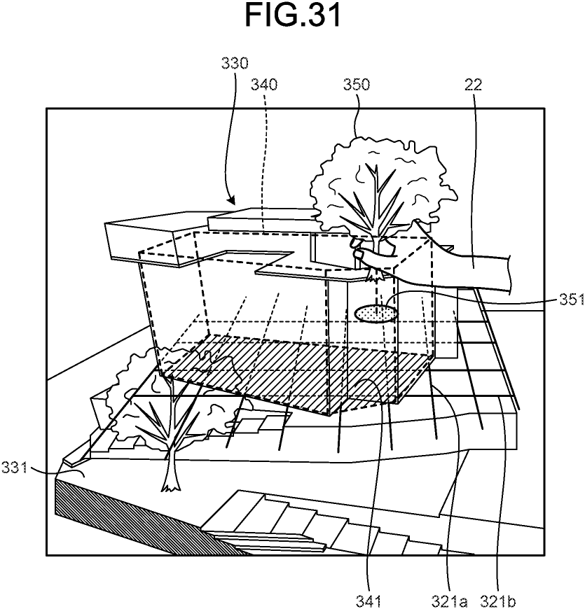

FIG. 29 is a schematic diagram schematically illustrating an operation according to the third embodiment. FIG. 29 is a diagram corresponding to FIG. 20 described above, and a grid is displayed on the virtual surface corresponding to the real surface designated in the building model 330.

For example, a case will be considered in which the user wearing the AR glasses 10 and wearing the hand sensor 20 on the hand 21 moves the hand 21 to a portion hidden by the line-of-sight of the user by the building model 330 and arranges the object along the grid. At this time, the AR glasses 10 detect the position of the hand 21 of the user based on each sensor signal of the hand sensor 20, and in a case where the hand 21 approaches the grid, a notification 500 is issued to the user in a predetermined pattern. The AR glasses 10 emit the notification 500 using, for example, at least one of vibration by the vibrator 2004 of the hand sensor 20 and sound output from the sound output unit 1202 of the AR glasses 10.

Furthermore, the AR glasses 10 can make the pattern of the notification 500 different according to the distance of the position of the detected hand 21 with respect to the grid. Furthermore, the pattern of the notification 500 can be made different depending on which direction the position of the detected hand 21 has come close to the grid line.

FIG. 30 is a schematic diagram illustrating an example of the pattern of the notification 500 according to the third embodiment. Here, a description will be given assuming that the notification 500 is emitted by a sound output from the sound output unit 1202 of the AR glasses 10. In the AR glasses 10, the control unit 100 estimates the position of the hand 21 of the user, for example, the position of the fingertip of the finger (in this example, the fingertip of the second finger) on which the IMUs 202 and 203 are worn in the hand 21 based on each sensor signal of the hand sensor 20. The present invention is not limited thereto, and the control unit 100 may set the predetermined portion of the hand sensor 20 as the position of the hand 21.

In FIG. 30, attention is paid to a specific grid line 321i among the grid lines along a vertical direction in the drawing and a specific grid line 321j among the grid lines along a horizontal direction in the drawing among the grid lines of the grid. Furthermore, in FIG. 30, positions 510a to 510e indicate estimated positions (fingertip positions) of the fingertips on the grid, respectively. Further, the notification 500 is illustrated as each of notifications 501a to 501e, respectively. In each of the notifications 501a to 501e, the passage of time is indicated in the right direction.

Here, the AR glasses 10 make a first sound output according to the distance between the estimated fingertip position and the grid line 321i and a second sound output according to the distance between the estimated fingertip position and the grid line 321j different from each other, thereby making the pattern of the notification 500 different. For example, the AR glasses 10 make the frequency of the first sound different from the frequency of the second sound. As an example, the AR glasses 10 make the frequency of the first sound lower than the frequency of the second sound. In this case, the first sound is heard, for example, as “Po” and the second sound is heard, for example, as “Pi”. As a result, the user can know which one of the grid line 321i along the vertical direction and the grid line 321j along the horizontal direction the fingertip position is closer to when placed on the grid.

The element for making the first sound and the second sound different is not limited to the frequency. For example, the AR glasses 10 may have different timbre (waveform) between the first sound and the second sound. Furthermore, in a case where the sound output unit 1202 is provided corresponding to each of both ears of the user, the localization of the first sound and the localization of the second sound may be different. Furthermore, the first sound and the second sound can be made different from each other by combining the plurality of elements.

The AR glasses 10 further change the frequency at which the first sound and the second sound are emitted according to the distance between the estimated fingertip position and the grid lines 321i and 321j, thereby making the pattern of the notification 500 different. More specifically, the AR glasses 10 increase the frequency at which the first sound is emitted as the estimated fingertip position approaches the grid line 321i. Similarly, the AR glasses 10 increase the frequency at which the second sound is emitted as the estimated fingertip position approaches the grid line 321j.

Note that, in a case where the estimated fingertip position is in the middle between a certain grid line and a grid line parallel and adjacent to the grid line, that is, in a case where the fingertip position is a position separated from the grid line by ½ of a grid interval in a direction orthogonal to the grid line, the AR glasses 10 do not emit the sound of the notification 500.

A more specific description will be given with reference to FIG. 30. The position 510a is an intersection position of the grid lines 321i and 312 j, and can be said to be a position closest to each of the grid lines 321i and 321j. In a case where the position 510a is estimated to be the fingertip position, the AR glasses 10 output the first sound “po” and the second sound “pi” from the sound output unit 1202 at a first frequency that is the highest frequency as illustrated as a notification 501a. For example, the AR glasses 10 continuously output the first sound like “popopopopo...” and continuously output the second sound like “pipipipi...” in parallel with the first sound.

Meanwhile, the position 510b is, for example, a center position of the grid, and is not close to any of the grid lines 321i and 321j. In other words, the position 510b is an intermediate position between the specific grid line 321i and the grid line on the right of the specific grid line among the grid lines along the vertical direction. In a case where it is estimated that the position 510b is the fingertip position, the AR glasses 10 do not output either the first sound or the second sound.

In a case where the estimated fingertip position is a position 510c that is a position on the grid line 321j and is a position separated from the grid line 321i by a distance of ½ of the grid interval in the horizontal direction, the AR glasses 10 do not output the first sound but output the second sound at the first frequency. For example, the AR glasses 10 continuously output only the second sound like “pipipipi...”.

In a case where the estimated fingertip position is a position on the grid line 321j and is at a position 510d which is a position closer than ½ of the grid interval in the horizontal direction from the grid line 321i, the AR glasses 10 output the second sound at the first frequency and output the first sound at a second frequency which is lower than the first frequency. For example, the AR glasses 10 continuously output the second sound like “pipipipi...” and intermittently output the first sound like “po, po, po,...” in parallel with the second sound.

Furthermore, in a case where the estimated fingertip position is a position on the grid line 321i and is at a position 510e which is a position closer than ½ of the grid interval in the vertical direction from the grid line 321j, the AR glasses 10 output the first sound at a high frequency and output the second sound at the second frequency. For example, the AR glasses 10 continuously output the first sound like “popopopo...” and intermittently output the second sound like “pi, pi, pi,...” in parallel with the first sound.

Note that, although an example of using sound as the notification 500 has been described above, this is not limited to this example. That is, the AR glasses 10 can control the operation of the vibrator 2004 provided in the hand sensor 20 according to the distance between the position (fingertip position) of the hand 21 and the grid line. In this case, it is conceivable to make the pattern of one vibration itself different for grid lines in different directions.

As described above, in the third embodiment, the notification 500 is issued to the user by the AR glasses 10 in a pattern according to the positional relationship between the hand 21 and the grid. As a result, even in a case where the hand 21 is at a position hidden from the line-of-sight of the user, the user can roughly grasp the position of the hand 21, and can easily perform work or the like at the position.

### 6. Fourth Embodiment

Next, a fourth embodiment of the present disclosure will be described. The fourth embodiment relates to display of the image of the hand 21 on the AR glasses 10 in a case where the hand 21 of the user goes around the back side of the real object in the line-of-sight direction of the user and is hidden behind the real object.

### 6-1. First Display Method

First, a first display method according to the fourth embodiment will be described. FIG. 31 is a schematic diagram for describing the first display method according to the fourth embodiment. FIG. 31 is a diagram corresponding to FIG. 20 described above, and a grid is displayed on the virtual surface corresponding to the real surface designated in the building model 330. In addition, an outline 340 of the building model 330 and a site 341 are illustrated. In the AR glasses 10, the site 341 is included in the plane 331 in the real space designated to display the grid in the virtual space. The line-of-sight of the user wearing the AR glasses 10 is directed toward the building model 330 from the front in FIG. 31, and the user cannot directly see the back side of the portion surrounded by the outline 340.

Here, a case where the user grips a tree model 350 with the hand 21 (not illustrated) on which the hand sensor 20 is worn and tries to arrange the tree model 350 in a region 351 included in the plane 331 will be considered. The region 351 is a region on the back side of the site 341 as viewed from the user, and cannot be viewed from the user by being blocked by the building model 330.

The AR glasses 10 estimate the position and posture of the hand 21 based on each sensor signal output from the hand sensor 20. The AR glasses 10 generate a virtual image 22 imitating the position and posture of the hand 21 based on the estimation result, and display the generated virtual image 22 to be superimposed on an image of the real space at a position in the virtual space corresponding to the estimated position of the hand 21. In this case, the AR glasses 10 may display the virtual image 22 so as not to transmit the image of the real space, or can display the virtual image 22 so as to transmit the image of the real space seen at the position of the virtual image 22. Furthermore, the AR glasses 10 also display the grid shielded by the building model 330 so as to be superimposed on the image of the real space.

As a result, the user can confirm the position of the hand 21 in the region that is obstructed by the real object and cannot be viewed, and for example, can more accurately execute the arrangement of the object with respect to the region.

### 6-2. Second Display Method

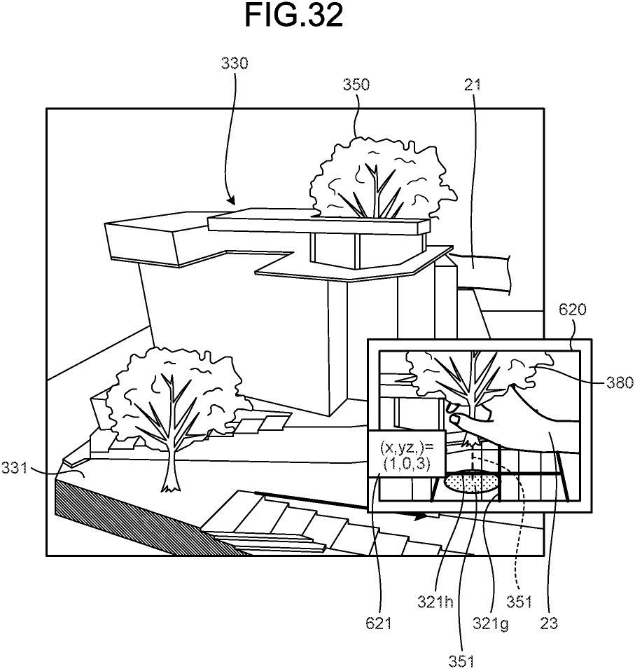

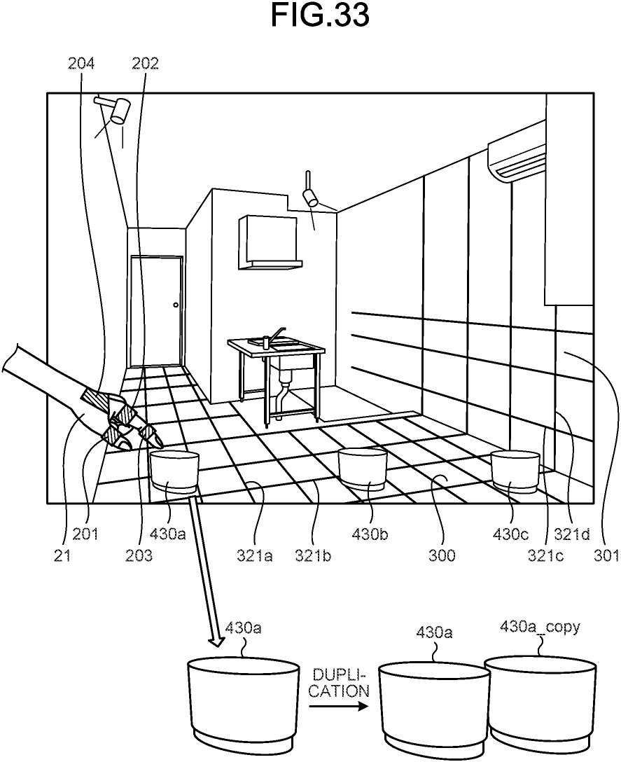

Next, a second display method according to the fourth embodiment will be described. FIG. 32 is a schematic diagram for describing the second display method according to the fourth embodiment. FIG. 32 is a diagram corresponding to FIG. 31 described above, and illustrates an example of a case where the user wearing the AR glasses 10 arranges the tree model 350 on the back side of the building model 330 as viewed from the user with the hand 21 wearing the hand sensor 20. Note that, in FIG. 32, the grid, the outline 340 of the building model 330, and the site 341 are omitted from FIG. 31.

In the second method according to the fourth embodiment, similarly to the above-described first method, the AR glasses 10 acquire the position and posture of the hand 21 based on each sensor signal of the hand sensor 20 worn on the hand 21. In addition, the AR glasses 10 acquire a three-dimensional model of the real object (building model 330 in this example) that blocks the line-of-sight of the user with respect to the hand 21. The three-dimensional model of the real object may be generated based on the image captured in advance using, for example, the outward camera 1101 or the like, or may be acquired from the server 3 in a case where the three-dimensional model is registered in advance in the server 3.

Based on the acquired position and posture of the hand 21 and the three-dimensional model of the real object (building model 330), the AR glasses 10 generate an image of a portion that cannot be viewed from the user position due to being blocked by the real object. In this case, the AR glasses 10 may generate an enlarged image obtained by enlarging the portion. This image includes a virtual image 23 of hand 21 based on the position and posture of hand 21.

The AR glasses 10 form a window 620 for information presentation in the field of view of the AR glasses 10, and display the generated image in the window 620. In the example of FIG. 32, coordinates 621 detected as the position of the hand 21 are displayed with respect to the window 620, and grid lines 321g and 321h corresponding to grids displayed based on the plane 331 are displayed.

By referring to the image displayed in this window 620, the user can easily perform, for example, fine adjustment of the position at the time of work of arranging the tree model 350 in the region 351 on the back side of the building model 330 as viewed from the user. Furthermore, the user can confirm the state of the back of the shielding object when viewed from the user based on the image of the window 620. In this case, the AR glasses 10 can display the state of the back of the shielding object in the window 620 regardless of the presence or absence of the hand 21 of the user.

Note that the image in the window 620 can be enlarged and reduced by a predetermined user operation or the like.

Also by this second method, the user can confirm the position of the hand 21 in an area that is obstructed by the real object and cannot be seen, and for example, can more accurately perform the arrangement of the object with respect to the region. Furthermore, in the second method, the user can confirm the state of the back of the shielding object regardless of whether or not the hand 21 of the user is at the position.

### 7. Fifth Embodiment

Next, a fifth embodiment of the present disclosure will be described. In the fifth embodiment, a designated real object is duplicated in a virtual space, and a duplicated virtual object in which the real object is duplicated is arranged in the virtual space.

FIG. 33 is a schematic diagram schematically illustrating an operation according to the fifth embodiment. FIG. 33 is a diagram corresponding to FIG. 23 described above, and illustrates a state in which real objects 430a, 430b, and 430c, which are chairs, for example, are arranged in the real space. Here, the real object 430a is set as an object to be duplicated. As schematically illustrated in the upper part of FIG. 33, the user designates the real object 430a to be duplicated with a fingertip or the like.

The real object 430a to be duplicated can be designated by the fingertip of the finger (for example, the second finger) on which the IMUs 202 and 203 of the hand 21 on which the hand sensor 20 is worn are provided. Alternatively, the finger of the user may be imaged by the outward camera 1101 of the AR glasses 10, and the real object 430a to be duplicated may be designated based on the captured image.

When designating the real object 430a to be duplicated, the user instructs the AR glasses 10 to duplicate the designated real object 430a. The instruction of duplication by the user may be issued by utterance, for example, or may be issued by operating an operator of controller 11.

Here, the three-dimensional model of the real object 430a has already been acquired in Step S100 of the flowchart of FIG. 10. When instructed to duplicate the real object 430a to be duplicated, the AR glasses 10 generate a virtual real object 430a_copy obtained by virtually duplicating the real object 430a based on the three-dimensional model of the real object 430a (see the lower view of FIG. 33). The AR glasses 10 arrange the generated virtual real object 430a_copy in the vicinity of the position corresponding to the position of the real object 430a in the real space in the virtual space.

The user can move the virtual real object 430a_copy in which the real object 430a is duplicated in the virtual space. For example, the user performs an operation of picking the virtual real object 430a_copy displayed in the virtual space with the finger, and further moves the finger in a picked state. When detecting the operation of picking and moving with the fingers based on the image captured by the outward camera 1101, the AR glasses 10 move the picked virtual real object 430a_copy in the virtual space according to the motion of the fingers.

In the fifth embodiment, as described above, the three-dimensional model of the real object in the real space is duplicated and arranged in the vicinity of the position corresponding to the position of the real object in the virtual space. For example, although there is only one real object in the real space, there is a case where it is desired to confirm a state in which a plurality of real objects are arranged in the real space. By applying the fifth embodiment, the user can easily confirm a state as when a plurality of real objects are arranged.

### 8. Sixth Embodiment

Next, a sixth embodiment of the present disclosure will be described. In the sixth embodiment, the AR glasses 10 generate a virtual space (referred to as a reduced virtual space) obtained by reducing the real space, and superimpose and display the virtual space on the real space in a non-transmissive manner.

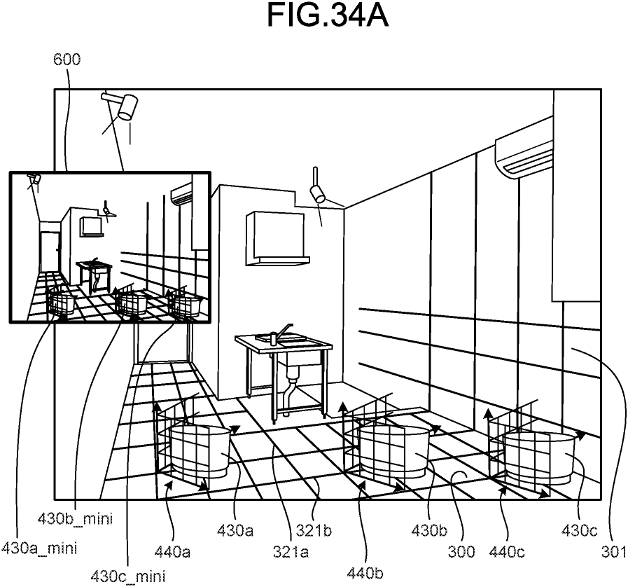

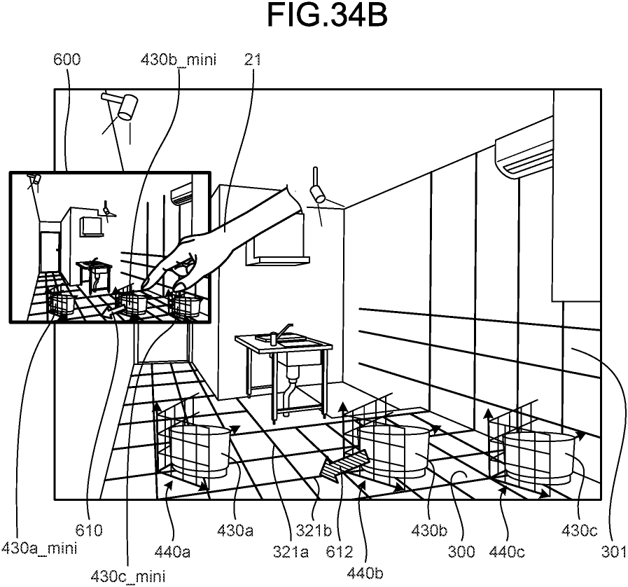

FIG. 34A is a schematic diagram illustrating a display example of the reduced virtual space according to the sixth embodiment. Note that FIG. 34A and FIG. 34B described later correspond to FIG. 25 described above.

The AR glasses 10 generate a virtual space (referred to as a reduced virtual space) obtained by reducing the real space based on the surrounding three-dimensional model acquired in Step S100 of FIG. 10. In a case where the virtual object is arranged in the virtual space corresponding to the real space, the AR glasses 10 generate the reduced virtual space including the virtual object. Then, the AR glasses 10 display the generated reduced virtual space so as to be superimposed on the real space in a non-transmissive manner, for example.

In this case, as described in the fifth embodiment, the three-dimensional model of each of the real objects 430a, 430b, and 430c in the real space has already been acquired. Reduced virtual real objects 430a_mini, 430b_mini, and 430c_mini respectively corresponding to the real objects 430a, 430b, and 430c in the reduced virtual space are generated using the three-dimensional models of the real objects 430a, 430b, and 430c, respectively.

FIG. 34A schematically illustrates a state in which the reduced virtual space is displayed in a region 600 superimposed on the real space in a non-transmissive manner. The user can easily grasp the entire state of the real space including the reduced virtual real objects 430a_mini, 430b_mini, and 430c_mini arranged corresponding to the real space in the virtual space by the reduced virtual space in the region 600 displayed in the AR glasses 10.

In addition, the AR glasses 10 can move the reduced virtual real objects 430a_mini, 430b_mini, and 430c_mini in the reduced virtual space in the reduced virtual space according to a user operation. FIG. 34B is a diagram according to a sixth embodiment. FIG. 34B is a schematic diagram schematically illustrating an operation of moving the reduced virtual real objects 430a_mini, 430b_mini, and 430c_mini in the reduced virtual space according to a user operation.

As an example, a case where the reduced virtual real object 430a_mini is moved will be described. The user performs an operation of, for example, picking the reduced virtual real object 430a_mini displayed in the region 600 with the fingers of the hand 21, and moves the reduced virtual real object 430a_mini in the reduced virtual space as indicated by an arrow 610, for example, while maintaining the picked state. The AR glasses 10 capture an image of the movement of the hand 21 of the user by the outward camera 1101, and detect a picking motion, a moving direction, and the like based on the captured image.

Note that the arrow 610 is merely for describing the movement of the reduced virtual real object 430a_mini, and is not an object actually displayed in the region 600.

Here, even when the reduced virtual real object 430a_mini is moved in the reduced virtual space, the corresponding real object 430a in the real space does not move. Therefore, the AR glasses 10 display an object (image) 612 indicating the movement (arrow 610) in the reduced virtual space at the position in the virtual space corresponding to the real object 430a in the real space, corresponding to the reduced virtual real object 430a_mini moved in the reduced virtual space. In the example of FIG. 34B, the object 612 is displayed as an arrow indicating a moving direction in which the real object 430a is moved corresponding to the movement indicated by the arrow 610 of the reduced virtual real object 430a_mini in the virtual space.

The user can reflect the movement of the reduced virtual real object 430a_mini in the reduced virtual space displayed in the region 600 on the movement of the real object 430a in the real space by actually moving the real object 430a in the real space according to the navigation by the object 612. In this manner, by displaying the object for reflecting the movement of the reduced virtual object in the reduced virtual space on the movement of the corresponding object in the real space, the user can easily determine the arrangement of each object in the real space.

Note that the effects described in the present specification are merely examples and are not limited, and other effects may be provided.

Note that the present technology can also have the following configurations.
(1) An information processing apparatus comprising:
   an acquisition unit configured to acquire motion information indicating a motion of a user; and
   a display control unit configured to perform display control on a display unit capable of superimposing and displaying a virtual space on a real space,
   wherein the display control unit specifies a real surface that is a surface in the real space based on the motion information, and displays a region image indicating a region for arranging a virtual object or a real object on a virtual surface that is a surface in the virtual space corresponding to the real surface according to an azimuth extracted based on the real surface.
(2) The information processing apparatus according to the above (1),
   wherein the acquisition unit acquires the motion information indicating a motion pointed by the user, and
   the display control unit specifies, as the real surface, a surface in the real space that intersects with a direction indicated by the pointing motion.
(3) The information processing apparatus according to the above (1),
   wherein the acquisition unit acquires the motion information indicating a motion in which the user comes in contact with an object in the real space, and
   the display control unit specifies, as the real surface, a surface in the real space that is brought into contact by the contact motion.
(4) The information processing apparatus according to the above (1),
   wherein the acquisition unit acquires the motion information indicating a standing motion of the user in the real space, and
   when the motion information indicating the standing motion of the user is acquired by the acquisition unit, the display control unit specifies, as the real surface, a surface in the real space where a vertical line drawn down from a head of the user intersects.
(5) The information processing apparatus according to any one of the above (1) to (4),
   wherein the acquisition unit acquires the motion information indicating a motion for moving a position pointed by the user, and
   the display control unit extracts the azimuth based on a trajectory on the real surface of movement caused by the motion of moving the indicated position.
(6) The information processing apparatus according to any one of the above (1) to (5),
   wherein the acquisition unit acquires motion information indicating a motion of the user based on an output of a sensor that is worn on a finger of the user and detects a position and a posture of the finger.
(7) The information processing apparatus according to any one of the above (1) to (4),
   wherein the display control unit extracts the azimuth based on feature information extracted from a captured image in which the real surface is imaged by an imaging unit capable of imaging the real space.
(8) The information processing apparatus according to the above (7),
   wherein the display control unit extracts a direction along an edge of the real surface as the azimuth based on the feature information.
(9) The information processing apparatus according to the above (7),
   wherein the display control unit extracts a direction along the pattern of the real surface as the azimuth based on the feature information.
(10) The information processing apparatus according to any one of the above (1) to (9),
   wherein the display control unit sets a coordinate space corresponding to a real object arranged in the real space in the virtual space, and displaying an image indicating the set coordinate space in the virtual space.
(11) The information processing apparatus according to any one of the above (1) to (10),
   wherein the display control unit detects a position at which the motion of the user has occurred in the region indicated by the region image based on the motion information, and performs notification according to position information indicating the detected position.
(12) The information processing apparatus according to the above (11),
   wherein the display control unit uses a sound output by a sound output unit as the notification.
(13) The information processing apparatus according to the above (11) or (12),
   wherein the display control unit uses a stimulus given to a tactile sense of the user by a stimulus unit as the notification.
(14) The information processing apparatus according to any one of the above (11) to (13),
   wherein the display control unit increases a frequency of the notification as a position indicated by the position information approaches a boundary of the region.
(15) The information processing apparatus according to any one of the above (11) to (14),
   wherein the display control unit performs the notification in a different pattern according to the azimuth of a boundary of the region where the position indicated by the position information approaches.
(16) The information processing apparatus according to any one of the above (1) to (15),
   wherein the display control unit generates a reduced virtual space obtained by reducing the real space based on three-dimensional information of the real space, and superimposing and displaying the reduced virtual space on the real space, and
   in a case where the motion information indicating the movement by the user of the virtual object corresponding to the real object in the real space, arranged in the reduced virtual space, is acquired by the acquisition unit, information indicating the movement is superimposed and displayed at a position corresponding to the real object in the real space.
(17) The information processing apparatus according to any one of the above (1) to (16),
   wherein the acquisition unit acquires motion information indicating a motion of the user based on an output of a sensor that is worn on a finger of the user and detects a position and a posture of the finger, and
   when it is determined that the finger of the user is hidden behind the real object as viewed from the display unit based on the motion information acquired based on the output of the sensor, the three-dimensional information of the real object arranged in the real space, and the position of the display unit, the display control unit causes the display unit to display an image indicating the finger of the user.
(18) The information processing apparatus according to any one of the above (1) to (17),
   wherein the display control unit displays the region image as a grid including one or more lines along the azimuth and one or more lines along an azimuth different from the azimuth.
(19) An information processing method comprising the following steps executed by a processor:
   an acquisition step of acquiring motion information indicating a motion of a user; and
   a display control step of performing display control on a display unit capable of superimposing and displaying a virtual space on a real space,
   wherein in the display control step,
   a real surface that is a surface in the real space based on the motion information is specified, and a region image indicating a region for arranging a virtual object or a real object is displayed on a virtual surface that is a surface in the virtual space corresponding to the real surface according to an azimuth extracted based on the real surface.
(20) An information processing program for causing a computer to execute the following steps:
   an acquisition step of acquiring motion information indicating a motion of a user; and
   a display control step of performing display control on a display unit capable of superimposing and displaying a virtual space on a real space,
   wherein in the display control step,
   a real surface that is a surface in the real space based on the motion information is specified, and a region image indicating a region for arranging a virtual object or a real object is displayed on a virtual surface that is a surface in the virtual space corresponding to the real surface according to an azimuth extracted based on the real surface.
(21) The information processing apparatus according to any one of the above (1) to (18),
   in which the acquisition unit acquires motion information indicating a motion of the user based on a captured image including a finger of the user imaged by an imaging unit capable of imaging the finger of the user.
(22) The information processing apparatus according to any one of the above (1) to (18),
   in which the acquisition unit acquires motion information indicating a motion of the user based on light emitted from a controller operated by the user for controlling the information processing apparatus.
(23) The information processing apparatus according to any one of the above (1) to (18),
   in which the acquisition unit includes acquires motion information indicating a motion of the user based on a direction of a line-of-sight of the user detected by a line-of-sight detection unit that detects the direction of the line-of-sight of the user.
(24) The information processing apparatus according to any one of the above (1) to (18),
   in which the display control unit further displays the region image on the virtual surface corresponding to another real surface defined based on the real surface.
(25) The information processing apparatus according to the above (24),
   in which the display control unit further displays the region image on the virtual surface corresponding to the other real surface connected to the real surface.
(26) The information processing apparatus according to the above (24) or (25),
   in which the display control unit further displays the region image on the virtual surface corresponding to a plane separated from the real surface in the real space.
(27) The information processing apparatus according to any one of the above (1) to (9),
   in which the display control unit includes:
      a coordinate space for arranging the real object in the real space is set in the virtual space, and an image indicating the set coordinate space is displayed in the virtual space.
(28) The information processing apparatus according to the above (16),
   in which the display control unit includes:
      moving a virtual object arranged in the reduced virtual space in the reduced virtual space based on the motion information.
(29) The information processing apparatus according to any one of the above (1) to (18) or (21) to (28),
   in which the display control unit acquires three-dimensional information of the real object arranged in the real space, and arranges a virtual object generated based on the acquired three-dimensional information in the virtual space.
(30) The information processing apparatus according to the above (17),
   in which the display control unit causes the display unit to display an image indicating a finger of the user at a position corresponding to the finger of the user in the virtual space while superimposing the image on the real space.
(31) The information processing apparatus according to the above (17),
   in which the display control unit causes the display unit to display an image including a finger of the user together with an image of the real object generated based on three-dimensional information of the real object viewed from a position of the finger of the user in a window different from a window in which a virtual space is superimposed and displayed in the real space.
(32) The information processing apparatus according to the above (31),
   in which the display control unit enlarges or reduces the display in another window according to an instruction of the user.

Reference Signs List

| 1a, 1b, 1c | AR GLASS SYSTEM |
|---|---|
| 3 | SERVER |
| 10 | AR GLASSES |
| 11 | CONTROLLER |
| 20 | HAND SENSOR |
| 21 | HAND |
| 22, 23 | VIRTUAL IMAGE |
| 100 | CONTROL UNIT |
| 110 | SENSOR UNIT |
| 120 | OUTPUT UNIT |
| 130 | COMMUNICATION UNIT |
| 140 | STORAGE UNIT |
| 201, 202, 203 | IMU |
| 204 | HAND SENSOR CONTROL UNIT |
| 300 | FLOOR SURFACE |
| 301 | WALL SURFACE |
| 318 | BOUNDARY |
| 321a, 321b, 321c, 321d, 321e, 321f, 321g, 321h, 321i, 321j | GRID LINE |
| 330 | BUILDING MODEL |
| 430a, 430b, 430c | REAL OBJECT |
| 440a, 440b, 440c | COORDINATE SPACE |
| 500, 501a, 501b, 501c, 501d, 501e | NOTIFICATION |
| 600 | REGION |
| 620 | WINDOW |
| 1001 | APPLICATION EXECUTION UNIT |
| 1002 | HEAD POSITION/POSTURE DETECTION UNIT |
| 1003 | OUTPUT CONTROL UNIT |
| 1004 | FINGER POSITION/POSTURE DETECTION UNIT |
| 1005 | FINGER GESTURE DETECTION UNIT |
| 1101 | OUTWARD CAMERA |
| 1102 | INWARD CAMERA |
| 1103 | MICROPHONE |
| 1104 | POSTURE SENSOR |
| 1105 | ACCELERATION SENSOR |
| 1106 | AZIMUTH SENSOR |
| 1201, 1201L, 1201R | DISPLAY UNIT |
| 1202 | SOUND OUTPUT UNIT |

1. An information processing apparatus comprising:
an acquisition unit configured to acquire motion information indicating a motion of a user; and
a display control unit configured to perform display control on a display unit capable of superimposing and displaying a virtual space on a real space,
wherein the display control unit specifies a real surface that is a surface in the real space based on the motion information, and displays a region image indicating a region for arranging a virtual object or a real object on a virtual surface that is a surface in the virtual space corresponding to the real surface according to an azimuth extracted based on the real surface.

2. The information processing apparatus according to claim 1,
wherein the acquisition unit acquires the motion information indicating a motion pointed by the user, and
the display control unit specifies, as the real surface, a surface in the real space that intersects with a direction indicated by the pointing motion.

3. The information processing apparatus according to claim 1,
wherein the acquisition unit acquires the motion information indicating a motion in which the user comes in contact with an object in the real space, and
the display control unit specifies, as the real surface, a surface in the real space that is brought into contact by the contact motion.

4. The information processing apparatus according to claim 1, wherein the acquisition unit acquires the motion information indicating a standing motion of the user in the real space, and
when the motion information indicating the standing motion of the user is acquired by the acquisition unit, the display control unit specifies, as the real surface, a surface in the real space where a vertical line drawn down from a head of the user intersects.

5. The information processing apparatus according to claim 1,
wherein the acquisition unit acquires the motion information indicating a motion for moving a position pointed by the user, and
the display control unit extracts the azimuth based on a trajectory on the real surface of movement caused by the motion of moving the indicated position.

6. The information processing apparatus according to claim 1,
wherein the acquisition unit acquires motion information indicating a motion of the user based on an output of a sensor that is worn on a finger of the user and detects a position and a posture of the finger.

7. The information processing apparatus according to claim 1,
wherein the display control unit extracts the azimuth based on feature information extracted from a captured image in which the real surface is imaged by an imaging unit capable of imaging the real space.

8. The information processing apparatus according to claim 7,
wherein the display control unit extracts a direction along an edge of the real surface as the azimuth based on the feature information.

9. The information processing apparatus according to claim 7,
wherein the display control unit extracts a direction along the pattern of the real surface as the azimuth based on the feature information.

10. The information processing apparatus according to claim 1,
wherein the display control unit sets a coordinate space corresponding to a real object arranged in the real space in the virtual space, and displaying an image indicating the set coordinate space in the virtual space.

11. The information processing apparatus according to claim 1,
wherein the display control unit detects a position at which the motion of the user has occurred in the region indicated by the region image based on the motion information, and performs notification according to position information indicating the detected position.

12. The information processing apparatus according to claim 11,
wherein the display control unit uses a sound output by a sound output unit as the notification.

13. The information processing apparatus according to claim 11,
wherein the display control unit uses a stimulus given to a tactile sense of the user by a stimulus unit as the notification.

14. The information processing apparatus according to claim 11,
wherein the display control unit increases a frequency of the notification as a position indicated by the position information approaches a boundary of the region.

15. The information processing apparatus according to claim 11,
wherein the display control unit performs the notification in a different pattern according to the azimuth of a boundary of the region where the position indicated by the position information approaches.

16. The information processing apparatus according to claim 1,
wherein the display control unit generates a reduced virtual space obtained by reducing the real space based on three-dimensional information of the real space, and superimposing and displaying the reduced virtual space on the real space, and
in a case where the motion information indicating the movement by the user of the virtual object corresponding to the real object in the real space, arranged in the reduced virtual space, is acquired by the acquisition unit, information indicating the movement is superimposed and displayed at a position corresponding to the real object in the real space.

17. The information processing apparatus according to claim 1,
wherein the acquisition unit acquires motion information indicating a motion of the user based on an output of a sensor that is worn on a finger of the user and detects a position and a posture of the finger, and
when it is determined that the finger of the user is hidden behind the real object as viewed from the display unit based on the motion information acquired based on the output of the sensor, the three-dimensional information of the real object arranged in the real space, and the position of the display unit, the display control unit causes the display unit to display an image indicating the finger of the user.

18. The information processing apparatus according to claim 1,
wherein the display control unit displays the region image as a grid including one or more lines along the azimuth and one or more lines along an azimuth different from the azimuth.

19. An information processing method comprising the following steps executed by a processor:
an acquisition step of acquiring motion information indicating a motion of a user; and
a display control step of performing display control on a display unit capable of superimposing and displaying a virtual space on a real space,
wherein in the display control step,
a real surface that is a surface in the real space based on the motion information is specified, and a region image indicating a region for arranging a virtual object or a real object is displayed on a virtual surface that is a surface in the virtual space corresponding to the real surface according to an azimuth extracted based on the real surface.

20. An information processing program for causing a computer to execute the following steps:
an acquisition step of acquiring motion information indicating a motion of a user; and
a display control step of performing display control on a display unit capable of superimposing and displaying a virtual space on a real space,
wherein in the display control step,
a real surface that is a surface in the real space based on the motion information is specified, and a region image indicating a region for arranging a virtual object or a real object is displayed on a virtual surface that is a surface in the virtual space corresponding to the real surface according to an azimuth extracted based on the real surface.
